(19) United States
(12) Patent Application Publication
(10) Pub. No.: US 2006/0095637 A1
(43) Pub. Date: May 4, 2006

(54) Bus control device, arbitration device, integrated circuit device, bus control method, and arbitration method

(76) Inventors: Atsushi Hirayama, Kyoto-shi (JP); Kenichi Kawaguchi, Kobe-shi (JP); Hideki Kawai, Takatsuki-shi (JP)

Correspondence Address: MCDERMOTT WILL & EMERY LLP, 600 13TH STREET, N.W., WASHINGTON, DC, 20005-3096, US

(21) Appl. No.: 11/259,760

(22) Filed: Oct. 27, 2005

(30) Foreign Application Priority Data
Nov. 1, 2004 (JP) 2004-318494

(51) Int. Cl. G06F 13/36

(52) U.S. Cl. 710/309

(57) ABSTRACT

A bus control device for controlling a bus system composed of a first bus and a second bus connected via a bridge unit. In the bus control device, a first arbitration unit obtains bandwidth information that specifies required bandwidth for data transfer between a first device connected to the first bus and a second device connected to the second bus, and gives a usage right for the first bus to the first device for a first allocated period set in accordance with the obtained bandwidth information; a second arbitration unit arbitrates a usage right for the second bus; and a notification unit notifies the bandwidth information from the first arbitration unit to the second arbitration unit. The second arbitration unit gives the usage right for the second bus to the bridge unit for a second allocated period set in accordance with the bandwidth information notified by the first arbitration unit.

This application is based on application No. 2004-318494 filed in Japan, the content of which is hereby incorporated by reference.

### BACKGROUND OF THE INVENTION

(1) Field of the Invention

The present invention relates to a bus system that has a plurality of buses connected via a bus bridge, and in particular to controlling transfer of data between the buses.

(2) Description of the Related Art

In a computer, devices such as a CPU and memory are connected via a common signal path called a bus. The number of devices that can be connected to one bus is limited from the point of view of safety and electric load. Therefore, the majority of computers are generally constructed with a bus system that uses a plurality of buses and a bus bridge that is connected to the buses and acts as a bridge for data transfer between the buses.

Applications including those for recording and playback of music, moving images and such that require a predetermined amount of data to be transferred with certainty cyclically from the memory to the CPU are executed in personal computers and the like that are constructed with a bus system such as the aforementioned.

However, when another application such as a browser application or a virus detection application is activated while moving images are being played by the moving image playback application, the bus and the CPU which were being used for moving image playback are also greatly spent on execution of the other application. This tends to cause a problem of jumps in sound, disturbances in video, and the like.

In particular, when the CPU and the memory are connected to respectively different buses and data transfer between the CPU and the memory is performed via a bus bridge, the parallel execution of the other applications lengthens the time for which data to be transferred stays in the buffer. This can lead to failure to meet the data transfer bandwidth required for stable moving images, and increases the possibility of jumps in sound, disturbances in video, and the like.

### SUMMARY OF THE INVENTION

In view of this problem, the present invention has an object of providing a bus control device, an arbitration device, an integrated circuit device, a bus control method, and an arbitration method that assure required bandwidth for transferring data via a plurality of buses in a bus system.

In order to achieve the stated object, the bus control device of the present invention is a bus control device for controlling a bus system, the bus system being composed of a first bus and a second bus connected via a bridge unit, the bus control device including: a first arbitration unit operable to obtain bandwidth information that specifies required bandwidth for data transfer between a first device connected to the first bus and a second device connected to the second bus, and give a usage right for the first bus to the first device for a first allocated period set in accordance with the obtained bandwidth information; a second arbitration unit operable to arbitrate a usage right for the second bus; and a notification unit operable to notify the bandwidth information from the first arbitration unit to the second arbitration unit, wherein the second arbitration unit gives the usage right for the second bus to the bridge unit for a second allocated period set in accordance with the bandwidth information notified by the first arbitration unit.

According to the stated structure, when the first device and the bridge unit are the respective master devices of the first bus and the second bus and drive the data transfer, the first arbitration unit gives the usage right for the first bus to the first device for the first allocated period set in accordance with the bandwidth information, and the second arbitration unit gives the usage right for the second bus to the bridge unit for the second allocated period set in accordance with the bandwidth information. Therefore, bandwidth for data transfer between the first device and the second device can be guaranteed.

Furthermore, since the bandwidth information is notified from the first arbitration unit to the second arbitration unit, simply designating the bandwidth information with respect to the first arbitration unit completes configuration of the bus control device relating to bandwidth for data transfer.

Here, the bandwidth information may express a first cycle and a transfer amount of data to be transferred between the first device and the second device in each first cycle, the first arbitration unit may set the first allocated period in each first cycle, the first allocated period being (i) equal to or longer than a time taken for transfer of the transfer amount of data between the bridge unit and the first device and (ii) shorter than the first cycle, and the second arbitration unit may set the second allocated period in each second cycle, the second cycle being equal to or shorter than the first cycle, and the second allocated period being (i) equal to or longer than a time taken for transfer of the transfer amount of data between the second device and the bridge unit and (ii) shorter than the second cycle.

According to the stated structure, the first arbitration unit gives the usage right for the first bus to the first device for the set first allocated period in each first cycle, and the second arbitration unit gives the usage right for the second bus to the bridge unit for the set second allocated period in each second cycle which is equal to or shorter than the first cycle. Therefore, the transfer amount of data can be transferred with certainty in each first cycle. In other words, a superior platform can be provided for applications that require transfer of a predetermined transfer amount of data each predetermined cycle.

Furthermore, in each one data transfer between the second device and the bridge unit, a unit transfer amount of data may be transferred, the unit transfer amount being less than the transfer amount, the second arbitration unit may set a plurality of separate allocated periods in each second cycle, a total of the separate allocated periods being equal to or longer than the second allocated period, and give the usage right for the second bus to the bridge unit for each set separate allocated period, and each separate allocated period may be equal to a time taken for transfer of the unit transfer amount of data between the second device and the bridge unit.

If the second allocated period is not an integral multiple of the separate allocated period, a situation may occur where data transfer of the last unit transfer amount of data is terminated if the usage right for the second bus is given to the bridge unit continuously for the second allocated period. However, the stated structure avoids this kind of situation and allows efficient data transfer.

Furthermore, the bus control device may further include the bridge unit, wherein the bridge unit has a storage unit capable of storing, up to a storage amount that is less than the transfer amount, data transferred between the first device and the second device, the first arbitration unit may set a plurality of first separate allocated periods in each first cycle, a total of the first separate allocated periods being equal to or longer than the first allocated period, and give the usage right for the first bus to the first device for each set first allocated period, the second arbitration unit may set a plurality of second separate allocated periods in each second cycle, a total of the second separate allocated periods being equal to or longer than the second allocated period, and give the usage right for the second bus to the bridge unit for each second allocated period, each first separate allocated period is equal to a time taken for transfer of the storage amount of data between the bridge unit and the first device, and each second separate allocated period is equal to a time taken for transfer of the storage amount of data between the second device and the bridge unit.

If the first device and the bridge unit are given the respective usage rights for the first bus and the second bus continuously, the bridge unit is unable to store new transfer data due to a concentrated supply of an amount of data that exceeds the storage amount. This causes a wait to transfer data. However, the stated structure avoids this kind of situation and allows efficient data transfer.

Furthermore, the bus control device may further include the bridge unit, wherein the bridge unit has a storage unit capable of storing the transfer amount or more of data, and the storage unit has an exclusive section for storing data transferred between the first device and the second device.

According to the stated structure, the bridge unit stores the transfer amount of data, which is the maximum amount of data that is supplied in each first cycle, and the first bus and the second bus transfer the transfer amount of data in each first cycle. This allows efficient data transfer without a situation occurring where the bridge unit is unable to store new transfer data.

Furthermore, the bus control device relating to the present invention is a bus control device for controlling a bus system, the bus system being composed of a first bus and a second bus connected via a first bridge unit and a third bus connected to the second bus via a second bridge unit, the bus control device including: a first arbitration unit operable to obtain bandwidth information that specifies required bandwidth for data transfer between a first device connected to the first bus and a second device connected to the third bus, and give a usage right for the first bus to the first device for a first allocated period set in accordance with the obtained bandwidth information; a second arbitration unit operable to arbitrate a usage right for the second bus; a first notification unit operable to notify the bandwidth information from the first arbitration unit to the second arbitration unit; a third arbitration unit operable to arbitrate a usage right for the third bus; and a second notification unit operable to notify the bandwidth information from the second arbitration unit to the third arbitration unit, wherein the second arbitration unit gives the usage right for the second bus to the bridge unit for a second allocated period set in accordance with the bandwidth information notified by the first arbitration unit, and the third arbitration unit gives the usage right for the third bus to the second bridge unit for a third allocated period set in accordance with the bandwidth information notified by the second arbitration unit.

According to the stated structure, when the first device, the first bridge unit and the second bridge unit are the respective master devices of the first bus, the second bus and the third bus and drive the data transfer, the first arbitration unit gives the usage right for the first bus to the first device in the first allocated period set in accordance with the bandwidth information, the second arbitration unit gives the usage right for the second bus to the bridge unit for the second allocated period set in accordance with the bandwidth information, and the third arbitration unit gives the usage right for the third bus to the second bridge unit for the third allocated period set in accordance with the bandwidth information. Therefore, required bandwidth for data transfer between the first device and the second device can be guaranteed.

Furthermore, since the bandwidth information is notified from the first arbitration unit to the second arbitration unit, and then further notified to the third arbitration unit, simply designating the bandwidth information with respect to the first arbitration unit completes configuration of the bus control device relating to bandwidth for data transfer.

Here, the bandwidth information may express a first cycle and a transfer amount of data to be transferred between the first device and the second device in each first cycle, the first arbitration unit may set the first allocated period in each first cycle, the first allocated period being (i) equal to or longer than a time taken for transfer of the transfer amount of data between the first bridge unit and the first device and (ii) shorter than the first cycle, and the second arbitration unit may set the second allocated period in each second cycle, the second cycle being equal to or shorter than the first cycle, and the second allocated period being (i) equal to or longer than a time taken for transfer of the transfer amount of data between the second device and the first bridge unit and (ii) shorter than the second cycle, and the third arbitration unit may set the third allocated period in each third cycle, the third cycle being equal to or shorter than the first cycle, and the third allocated period being (i) equal to or longer than a time taken for transfer of the transfer amount of data between the second device and the second bridge unit and (ii) shorter than the third cycle.

According to the stated structure, the first arbitration unit gives the usage right for the first bus to the first device for the set first allocated period in each first cycle, the second arbitration unit gives the usage right for the second bus to the first bridge unit for the set second allocated period in each second cycle which is equal to or shorter than the first cycle, and the third arbitration unit gives the usage right for the third bus to the second bridge unit for the set third allocated period in each third cycle which is equal to or shorter than the first cycle. Therefore, the transfer amount of data can be transferred with certainty in each first cycle.

Furthermore, the bus control device of the present invention is a bus control device for controlling a bus system, the bus system being composed of a first bus and a third bus connected via a first bridge unit and second bus connected to the third bus via a second bridge unit, the bus control device including: a first arbitration unit operable to obtain first bandwidth information that specifies required bandwidth for data transfer between a first device connected to the first bus and a third device connected to the third bus, and give a usage right for the first bus to the first device for a first allocated period set in accordance with the obtained first bandwidth information; a second arbitration unit operable to obtain second bandwidth information that specifies required bandwidth for data transfer between a second device connected to the second bus and the third device, and give a usage right for the second bus to the second device for a second allocated period set in accordance with the obtained second bandwidth information; a third arbitration unit operable to arbitrate a usage right for the third bus; a first notification unit operable to notify the first bandwidth information from the first arbitration unit to the third arbitration unit; and a second notification unit operable to notify the second bandwidth information from the second arbitration unit to the third arbitration unit, wherein the third arbitration unit gives the usage right for the third bus to the first bridge unit for a third allocated period set in accordance with the first bandwidth information, and gives the usage right for the third bus to the second bridge unit for a fourth allocated period set in accordance with the second bandwidth information.

According to the stated structure, when the first device, the second device, the first bridge unit and the second bridge unit are the respective master devices of the first bus, the second bus and the third bus and drive the data transfer, the first arbitration unit gives the usage right for the first bus to the first device for the first allocated period set in accordance with the bandwidth information, the second arbitration unit gives the usage right for the second bus to the bridge unit for the second allocated period set in accordance with the bandwidth information, and the third arbitration unit gives the usage right for the third bus to the second bridge unit for the third allocated period set in accordance with the bandwidth information, as well as giving the usage right for the third bus to the second bridge unit for the fourth allocated period set in accordance with the bandwidth information. Therefore, required bandwidth for data transfer between the first device and the third device and between the second device and the third device can be guaranteed.

Here, the first bandwidth information may express a first cycle and a first transfer amount of data to be transferred between the first device and the second device in each first cycle, the second bandwidth information may express a second cycle and a second transfer amount of data to be transferred between the second device and the third device in each second cycle, the first arbitration unit may set the first allocated period in each first cycle, the first allocated period being (i) equal to or longer than a time taken for transfer of the first transfer amount of data between the first bridge unit and the first device and (ii) shorter than the first cycle, the second arbitration unit may set the second allocated period in each second cycle, the second allocated period being (i) equal to or longer than a time taken for transfer of the transfer amount of data between the second bridge unit and the second device and (ii) shorter than the second cycle, the third arbitration unit may (a) set a third allocated period in each third cycle, the third cycle being longer that each of the first cycle and the second cycle, and the third allocated period being (i) equal to or longer than a time taken for transfer of the first transfer amount of data between the third device and the first bridge unit and (ii) shorter than the third cycle, and (b) set a fourth allocated period in each third cycle, the fourth allocated period being equal to or longer than a time taken for transfer of the second transfer amount of data between the third device and the second bridge unit.

According to the stated structure, the first arbitration unit gives the usage right for the first bus to the first device for the set first allocated period in each first cycle, the second arbitration unit gives the usage right for the second bus to the second device for the set second allocated period in each second cycle, the third arbitration unit gives the usage right for the third bus to the first bridge unit for the set third allocated period each third cycle which is equal to or shorter than the first cycle, as well as giving the usage right for the third bus to the second bridge unit for the set fourth allocated period in each fourth cycle which is equal to or shorter than the second cycle. Therefore, predetermined bandwidth for data transfer between the first device and the third device and between the second device and the third device can be guaranteed.

In addition, since the first bandwidth information is notified from the first arbitration unit to the third arbitration unit, and the second bandwidth information is notified from the second arbitration unit to the third arbitration unit, simply designating the first bandwidth information with respect to the first arbitration unit and the second bandwidth information with respect to the second arbitration unit completes configuration of the bus control device relating to bandwidth for data transfer.

Furthermore, the arbitration device relating to the present invention is an arbitration device for arbitrating a right to use a first bus in a bus system, the bus system being composed of the first bus and a second bus connected via a bridge unit, the arbitration device including; an obtaining unit operable to obtain bandwidth information that specifies required bandwidth for data transfer between a first device connected to the first bus and a second device connected to the second bus; an arbitration unit operable to give the right to use the first bus to the first device for an allocated period set in accordance with the obtained bandwidth information; and a transmission unit operable to transmit bandwidth information to an arbitration device that arbitrates a usage right for the second bus.

Furthermore, the arbitration device relating to the present invention is an arbitration device that arbitrates a usage right for a second bus in a bus system, the bus system being composed of a first bus and the second bus connected via a bridge unit, the arbitration device including: a reception unit operable to receive, from an arbitration device that arbitrates a usage right for the first bus, bandwidth information that specifies required bandwidth for data transfer between a first device connected to the first bus and a second device connected to the second bus; and an arbitration unit operable to give the usage right for the second bus to the bridge unit for an allocated period set in accordance with the received bandwidth information.

According to these structures, the bandwidth information is conveyed from a former arbitration device to a latter arbitration device. This guarantees bandwidth for data transfer with the two devices by simply designating the bandwidth information with respect to the former device.

Furthermore, the integrated circuit device relating to the present invention is an integrated circuit device for controlling a bus system, the bus system being composed of a first bus and a second bus connected via a bridge unit, the integrated circuit device including: an input circuit operable to receive input of bandwidth information that specifies required bandwidth for data transfer between a first device connected to the first bus and a second device connected to the second bus; a first arbitration circuit operable to output a first grant signal showing that the first device has a usage right for the first bus for a first allocated period set in accordance with the input bandwidth information; a second arbitration circuit operable to arbitrate a usage right for the second bus; and a notification circuit operable to notify the bandwidth information from the first arbitration circuit to the second arbitration circuit, wherein the second arbitration circuit outputs a second grant signal showing that the bridge unit has a usage right for the second bus for a second allocated period set in accordance with the bandwidth information notified by the first arbitration circuit.

Furthermore, the input unit, as the bandwidth information, may receive input of a first cycle and a transfer amount showing an amount of data to be transferred between the first device and the second device in each first cycle, the first arbitration circuit may set the first allocated period in each first cycle, the first allocated cycle being (i) equal to or longer than a time taken for transfer of the transfer amount of data between the bridge unit and the first device and (ii) shorter than the first cycle, and the second arbitration circuit may set the second allocated period each second cycle, the second cycle being equal to or shorter than the first cycle, and the second allocated period being (i) equal to or longer than a time taken for transfer of the transfer amount of data between the second device and the bridge unit and (ii) shorter than the second cycle.

Furthermore, the integrated circuit device relating to the present invention is an integrated circuit device for arbitrating a usage right for a first bus in a bus system, the bus system being composed of the first bus and a second bus connected via a bridge unit, the integrated circuit device including: an input circuit operable to obtain bandwidth information that specifies required bandwidth for data transfer between a first device connected to the first bus and a second device connected to the second bus; and an arbitration circuit operable to output a first grant signal showing that the first device has a usage right for the first bus for an allocated period set in accordance with the obtained bandwidth information; and an output circuit operable to notify the bandwidth information to an integrated circuit device that arbitrates a usage right for the second bus.

Furthermore, the integrated circuit device relating to the present invention is an integrated circuit device for arbitrating a usage right for a second bus in a bus system, the bus system being composed of a first bus and the second bus connected via a bridge unit, the integrated circuit device including: an input circuit operable to obtain bandwidth information that specifies required bandwidth for data transfer between a first device connected to the first bus and a second device connected to the second bus, from an integrated circuit device that arbitrates a usage right for the first bus; and an arbitration circuit operable to give the usage right for the second bus to the bridge unit for an allocated period set in accordance with the obtained bandwidth information.

These structures obtain the same effects as those obtained according to the structure of the aforementioned bus control devices and arbitration devices.

Furthermore, the bus control method relating to the present invention is a bus control method for controlling a bus system, the bus system being composed of a first bus and a second bus connected via a bridge unit, a first arbitration unit for arbitrating a usage right for the first bus, and a second arbitration unit for arbitrating a usage right for the second bus, the bus control method including the steps of: the first arbitration unit obtaining bandwidth information that specifies required bandwidth for data transfer between a first device connected to the first bus and a second device connected to the second bus, and giving the usage right for the first bus to the first device for a first allocated period set in accordance with the obtained bandwidth information; the first arbitration unit notifying the bandwidth information to the second arbitration unit; and the second arbitration unit giving the usage right for the second bus to the bridge unit for a second allocated period set in accordance with the bandwidth information notified by the first arbitration unit.

Furthermore, the bandwidth information may express a first cycle and a transfer amount of data to be transferred between the first device and the second device in each first cycle, the first arbitration unit may set the first allocated period in each first cycle, the first allocated period being (i) equal to or longer than a time taken for transfer of the transfer amount of data between the bridge unit and the first device and (ii) shorter than the first cycle, and the second arbitration unit may set the second allocated period in each second cycle, the second cycle being equal to or shorter than the first cycle, and the second allocated period being (i) equal to or longer than a time taken for transfer of the transfer amount of data between the second device and the bridge unit and (ii) shorter than the second cycle.

Furthermore, the bus control method relating to the present invention is an arbitration method for arbitrating a usage right for a first bus in a bus system, the bus system being composed of the first bus and a second bus connected via a bridge unit, and a second arbitration unit for arbitrating a usage right for the second bus, the arbitration method including the steps of: obtaining bandwidth information that specifies required bandwidth for data transfer between a first device connected to the first bus and a second device connected to the second bus; giving the usage right for the first bus to the first device for an allocated period set in accordance with the obtained bandwidth information; and transmitting the bandwidth information to the second arbitration unit.

Furthermore, the bus control method relating to the present invention is an arbitration method for arbitrating a usage right for a second bus in a bus system, the bus system being composed of a first bus and the second bus connected via a bridge unit, and a first arbitration unit for arbitrating a usage right for the first bus, the arbitration method including the steps of: receiving, from the first arbitration unit, bandwidth information that specifies required bandwidth for data transfer between a first device connected to the first bus and a second device connected to the second bus; and giving the usage right for the second bus to the bridge unit for an allocated period set in accordance with the received bandwidth information.

Controlling buses or arbitrating the usage rights thereof according to these methods obtains the same effects as those obtained according to the structure of the aforementioned bus control devices and arbitration devices.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 shows the structure of a bus system 1;

FIG. 2 shows one example of signal lines in a first bus;

FIG. 3 is a flowchart showing operations of the bus system 1;

FIG. 4 is a flowchart showing operations of a first arbitration unit 11;

FIG. 5 is a flowchart showing operations of a second arbitration unit 12;

FIG. 6 shows the structure of a bus system 1a;

FIG. 7 is a flowchart showing operations of a second arbitration unit 13;

FIG. 8 is a timing chart showing temporal change of principal signals that appear in the first bus and a second bus;

FIG. 9 is a timing chart showing temporal change of principal signals that appear in the first bus and the second bus;

FIG. 10 is a timing chart showing temporal change of principal signals that appear in the first bus and the second bus;

FIG. 11 is a timing chart showing temporal change of principal signals that appear in the first bus and the second bus;

FIG. 12 is a timing chart showing temporal change of data stored in a bridge unit 21a;

FIG. 13 is a timing chart showing temporal change of data stored in the bridge unit 21a;

FIG. 14 shows the structure of a bus system 1b;

FIG. 15 shows the structure of a bus system 1c;

FIG. 16 shows the structure of a bus system 1d;

FIG. 17 shows the structure of a bus system 1e;

FIG. 18 is a timing chart showing an example of operations when the first bus the second bus have identical arbitration cycles;

FIG. 19 is a timing chart showing an example of operations when the first bus the second bus have identical arbitration cycles;

FIG. 20 is a timing chart showing an example of operations with a minimum of idle cycles;

FIG. 21 is a timing chart showing an example of operations with a minimum of idle cycles;

FIG. 22 is a timing chart showing an example of operations when the first bus is freed when the first device has ended bus transaction;

FIG. 23 shows the structure of a bus system 2;

FIG. 24 is a flowchart showing an outline of operations of the bus system 2;

FIG. 25 is a flowchart showing operations of a second arbitration unit 14;

FIG. 26 is a flowchart showing operations of a third arbitration unit 15;

FIG. 27 shows the structure of a bus system 2a;

FIG. 28 shows the structure of a bus system 3; and

FIG. 29 is a flowchart showing operations of a third arbitration unit 17.

### DESCRIPTION OF THE PREFERRED EMBODIMENTS

The following describes embodiments of the present invention with use of the drawings.

### First Embodiment

### Structure

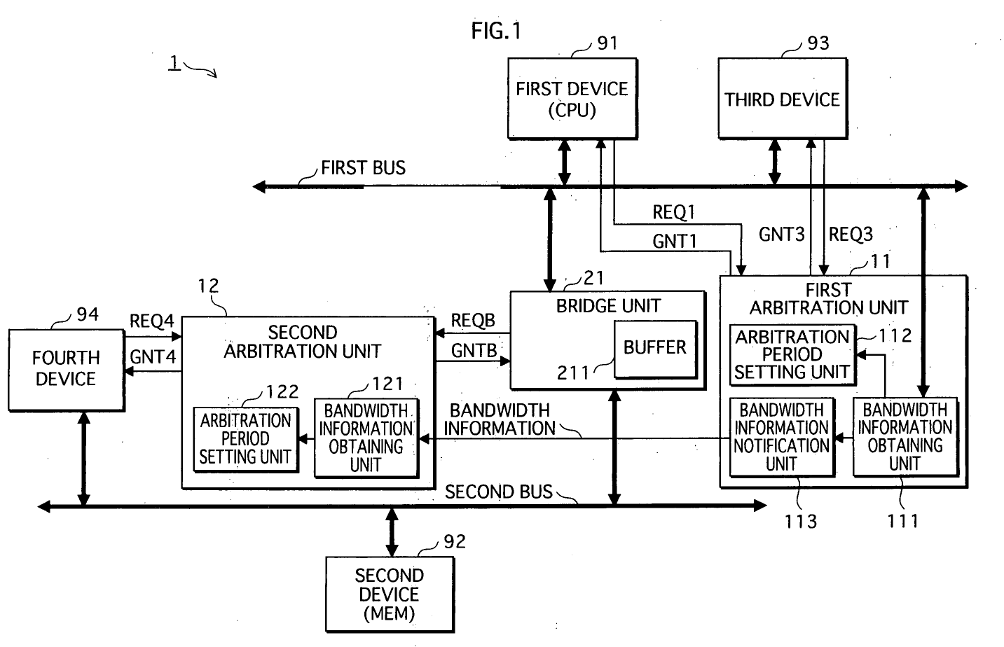

FIG. 1 shows the structure of a bus system 1 that includes a bus control device relating to the first embodiment.

The bus system 1 includes a first bus and a second bus which are connected via a bridge unit 21, a first device 91 and a third device 93 which are connected to the first bus, a second device 92 and a fourth device 94 which are connected to the second bus, a first arbitration unit 11 which arbitrates a usage right for the first bus, and a second arbitration unit 12 which arbitrates a usage right for the second bus.

The first arbitration unit 11, the second arbitration unit 12 and the bridge unit 21 are implemented with an integrated circuit.

The bus control device is composed of the first arbitration unit 11 and the second arbitration unit 12.

The first arbitration unit 11 has a bandwidth information obtaining unit 111, an arbitration period setting unit 112, and a bandwidth information notification unit 113.

The second arbitration unit 12 has a bandwidth information obtaining unit 121 and an arbitration period setting unit 122.

The bridge unit 21 has a buffer 211 that temporarily stores data to be transferred between the first bus and the second bus.

The first device 91 is a CPU (Central Processing Unit), and the second device 92 is a memory unit that stores MP-3 (MPEG-1 Audio Layer-3) data.

### Bus Structure

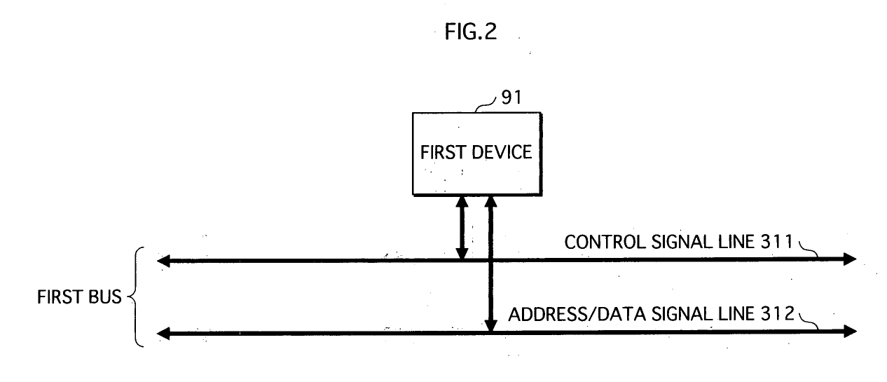

FIG. 2 is a structural diagram showing an example of signal lines in the first bus.

As shown in FIG. 2, the first bus includes a control signal line 311 and an address/data signal line 312.

The control signal line 311 includes a read/write signal line, a phase signal line, and a bus response type signal line.

The address/data signal line 312 has a plurality of signal lines (for example, 32 signal lines) that multiplex addresses and data, and convey either an address signal or a data signal each bus cycle.

This kind of structure is known, for instance, as a PCI (Peripheral Component Interconnect) bus.

The second bus has the same structure.

### Operations

In the bus system 1, when the first device 91 performs playback processing with respect to the MP3 data stored in the second device 92, arbitration of the usage right for the first bus and the second bus is performed in order to guarantee bandwidth for data transfer between the first device 91 and the second device 92.

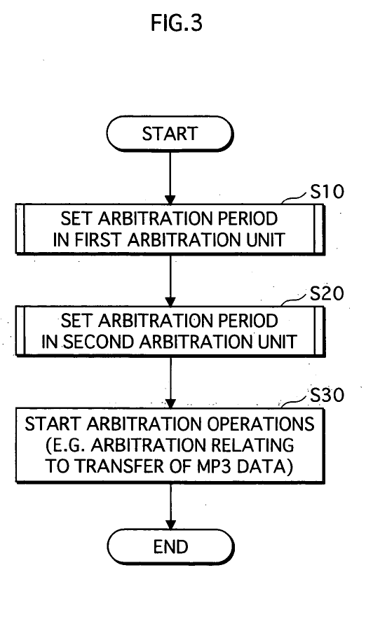

FIG. 3 is a flowchart expressing an outline of operations of the bus system 1.

First, the period for which the usage right for the first bus is given to the first device is set in the first arbitration unit 11 (step S10), and the period for which the usage right for the second bus is given to the bridge unit 21 is set in the second arbitration unit 12 (step S20).

These operations complete configuration of the bus control device relating to the data transfer bandwidth.

Next, arbitration operations commence in accordance with what has been set in the first arbitration unit 11 and the second arbitration unit 12, and the bus system 1 performs transfer of data (MP3 data, for instance) (step S30).

### Operations of the First Arbitration Unit 11

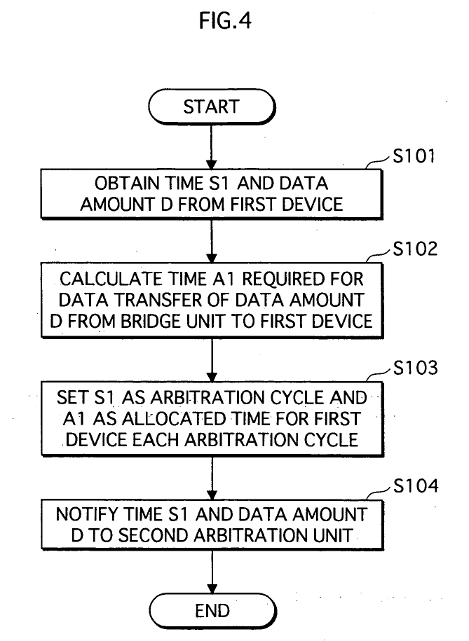

FIG. 4 is a flowchart expressing details of setting operations in the first arbitration unit 11.

The bandwidth information obtaining unit 111 obtains, as bandwidth information, a time S1 and a data amount D from the first device 91 (step S101).

This bandwidth information shows that transfer is requested of a data amount D every time S1 between the first device 91 and the second device 92. Here, the time S1 corresponds to the first cycle time in the claims, and the data amount D corresponds to the transfer request amount in the claims.

The arbitration period setting unit 112 calculates a time A1 required to transfer the data amount D from the bridge unit 21 to the first device 91 (step S102), and sets S1 as an arbitration cycle of the first bus and A1 as an allocated time for which the usage right for the first bus is given to the first device 91 each arbitration cycle (step S103).

The bandwidth information notification unit 113 notifies the second arbitration unit 12 of the time S1 and the data amount D (step S104).

### Operations of the Second Arbitration Unit 12

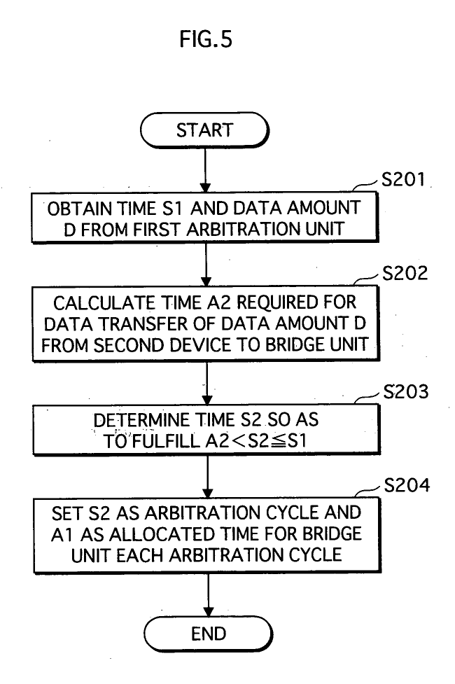

FIG. 5 is a flowchart expressing details of setting operations in the second arbitration unit 12.

The bandwidth information obtaining unit 121 obtains, as bandwidth information, the time S1 and the data amount D from the arbitration unit 11 (step S201).

The arbitration period setting unit 122 calculates a time A2 required to transfer the data amount D from the second device 92 to the bridge unit 21 (step S202), determines a time S2 that fulfills A2<S2≦S1 (step S203), and sets S2 as the arbitration cycle of the second bus and A2 as the allocated time for which the usage right for the second bus is given to the bridge unit 21 (step S204).

By the first arbitration unit 11 and the second arbitration unit 12 arbitrating bus usage rights in accordance with the described settings, the usage rights for the first bus and the second bus are given respectively to the first device 91 and the bridge unit 21 for a period necessary to ensure the bandwidth shown in the bandwidth information.

Here, since the arbitration cycle S2 of the second bus is equal to or shorter than the arbitration cycle S1 of the first bus, the data amount D is transferred with certainty each time S1 between the first device and the second device.

### FIRST MODIFICATION EXAMPLE

The following describes a preferred first modification example of a bus system that performs data transfer of a unit transfer amount d, which is smaller than the data amount D, in each one data transfer between the first device 91 and the second device 92.

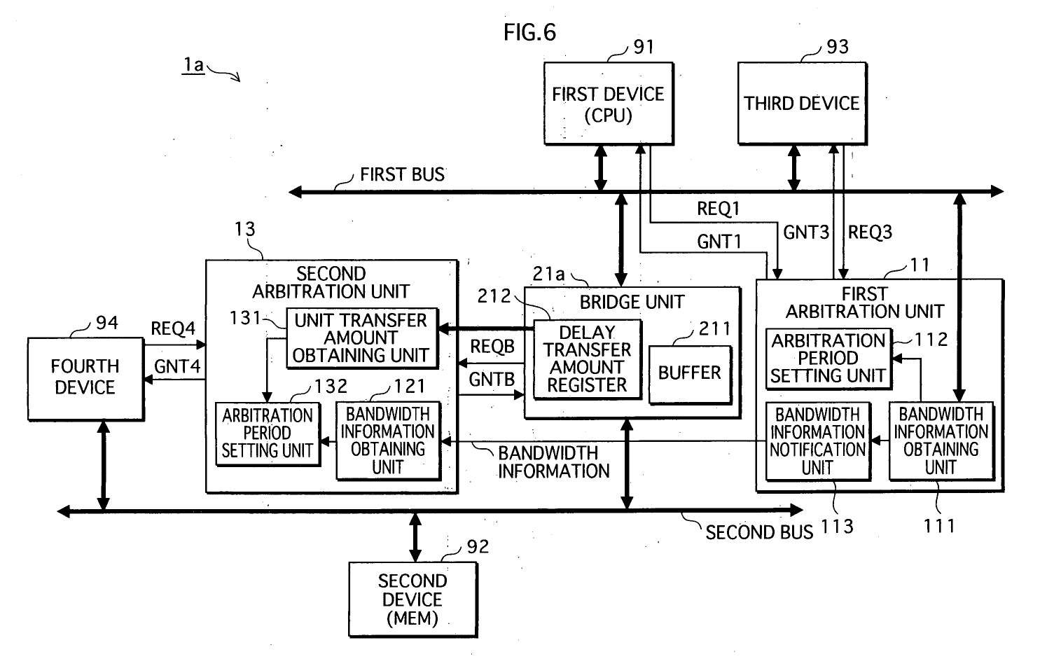

FIG. 6 shows the structure of a bus system 1a relating the first modification example.

The bus system 1a differs from the bus system 1 shown in FIG. 1 in terms of the addition of a delay transfer amount register 212 in a bridge unit 21a, the addition of a unit transfer amount obtaining unit 131 to a second arbitration unit 13, and differing operations by an arbitration period setting unit 132.

A delay transfer amount register 212 stores the unit transfer amount d of which it has been notified from the first device 91, for example.

The unit transfer amount obtaining unit 131 obtains the unit transfer amount d from the delay transfer amount register 212.

An arbitration period setting unit 132 divides the period for which the bridge unit 21a will be given the usage right for the second bus to ensure the bandwidth shown in the bandwidth information, into the time taken for data transfer of the unit transfer amount d between the second device 92 and the bridge unit 21a, and sets the time.

### Operations of the Second Arbitration Unit 13 in the First Modification Example

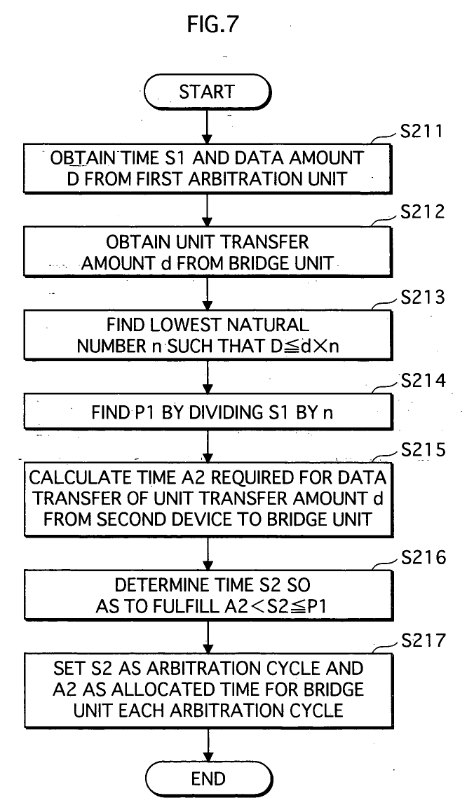

FIG. 7 is a flowchart expressing details of setting operations in the second arbitration unit 13.

The bandwidth information obtaining unit 121 obtains, as bandwidth information, the time S1 and the data amount D from the first arbitration unit 11 (S211), and the unit transfer amount obtaining unit 131 obtains the unit transfer amount d from the bridge unit 21 (step S212).

The arbitration period setting unit 132 finds the smallest natural number n that when multiplied with the unit transfer amount d1 will result in a value that is equal to or greater than the data amount D (step S213), and finds P1 by dividing the time S1 by n (step S214). Next, the arbitration period setting unit 132 calculates a time A2 required for data transfer of the unit transfer amount d from the second device 92 to the bridge unit 21 (step 215), determines a time S2 that fulfills A2<S2≦P1 (step S216), and sets S2 as the arbitration cycle of the second bus, and A2 as the allocated time for which the usage right for the second bus is given to the bridge unit 21 each arbitration cycle (step S217).

### Specific Example of Operations of the Bus System 1a

The following describes a specific example of configuration and data transfer operations of the bus system 1a.

In this specific example, transfer of 32 bytes of data between the first device 91 and the second device 92 each 36 bus cycles is requested. In other words, the time S1 shown by the bandwidth information is 36 bus cycles, and the data amount D shown by the bandwidth information is 32 bytes. Furthermore, the unit transfer amount d is 16 bytes.

Furthermore, the first bus and the second bus are each an address/data multiplex-type bus of a 4-byte (32-bit) width, and operate with a bus cycle of the same frequency.

The first arbitration unit 11 stores in advance information showing that in each one data transfer on the first bus, at least three bus cycles are necessary for performing issuing of bus commands and soon, in addition to the bus cycles for transferring the data itself.

Based on this information, the first arbitration unit 11 calculates the time required for transferring 32 bytes of data from the bridge unit 21a to the first device 91, the time being 11 bus cycles, which is the eight bus cycles for transferring the main body of the data plus the three bus cycles for issuing a bus command. The first arbitration unit 11 sets the allocation time A1 as 18 bus cycles, which is longer than this calculated time.

In accordance with this setting, the first arbitration unit 11 gives the usage right for the first bus to the first device 91 for 18 bus cycles in each 36 bus cycles.

Having recognized that the unit transfer amount is 16 bytes, the second arbitration unit 12 finds n to be 2 and P1 to be 19. Next, based on that information, the second arbitration unit 12 calculates the allocated time A2 taken for transfer of 16 bytes of data from the second device 92 to the bridge unit 21a as nine bus cycles. The second arbitration unit 12 sets the arbitration cycle S2 as 18 bus cycles, and the allocated time A2 as nine bus cycles.

In accordance with these settings, the second arbitration unit 12 gives the usage right for the second bus to the bridge unit 21 for nine cycles in each 18 bus cycles.

The following describes specific data transfer operations performed in accordance with the described settings.

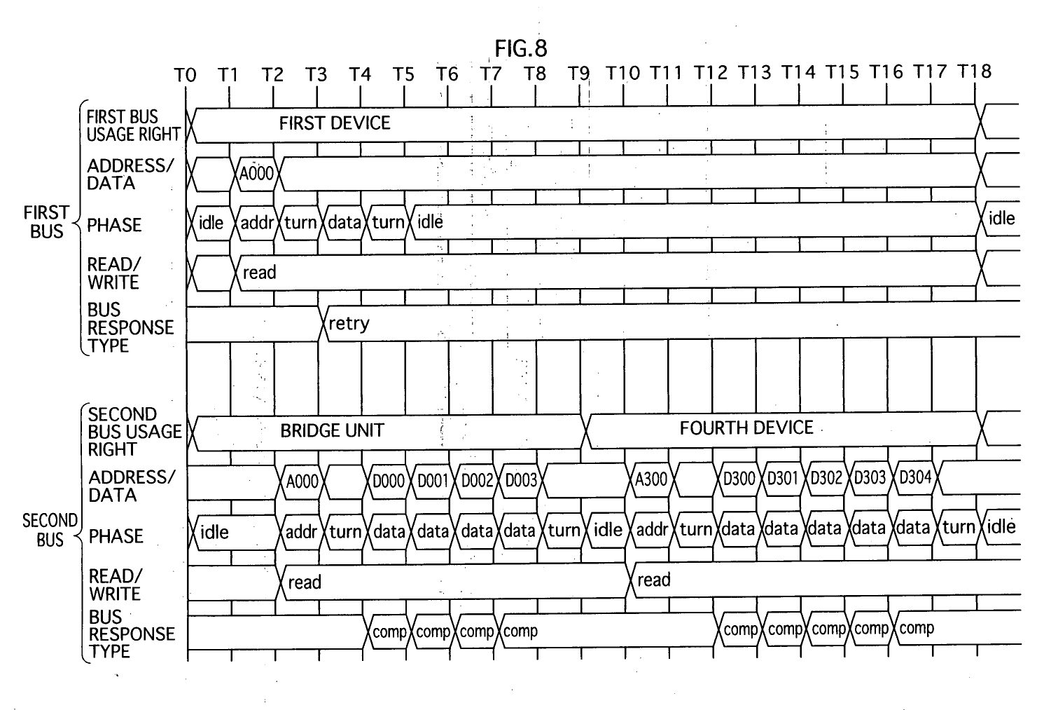

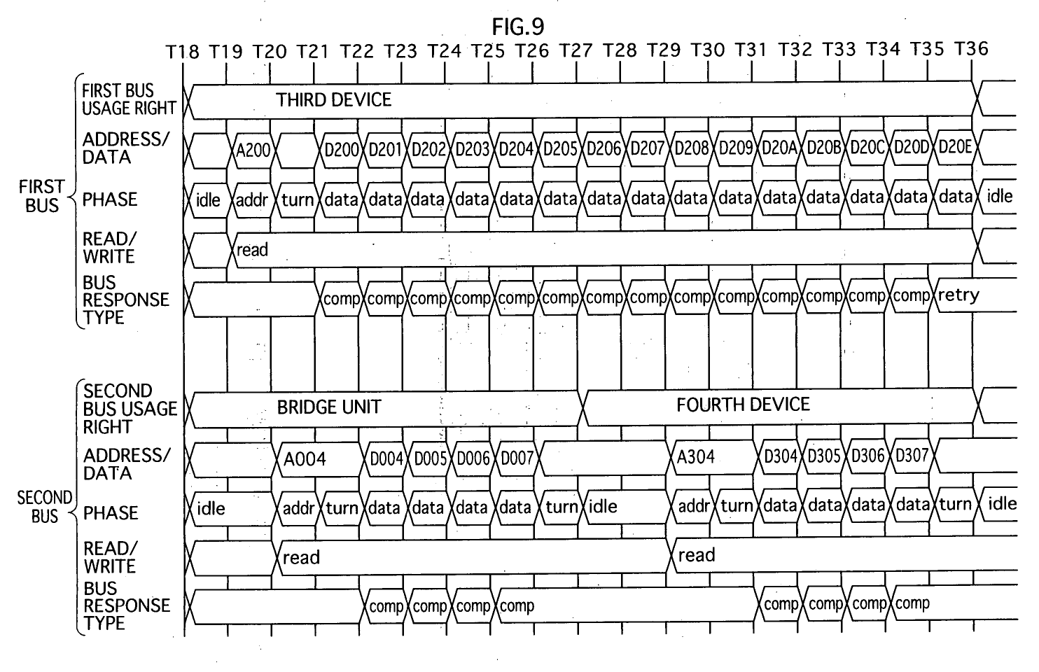

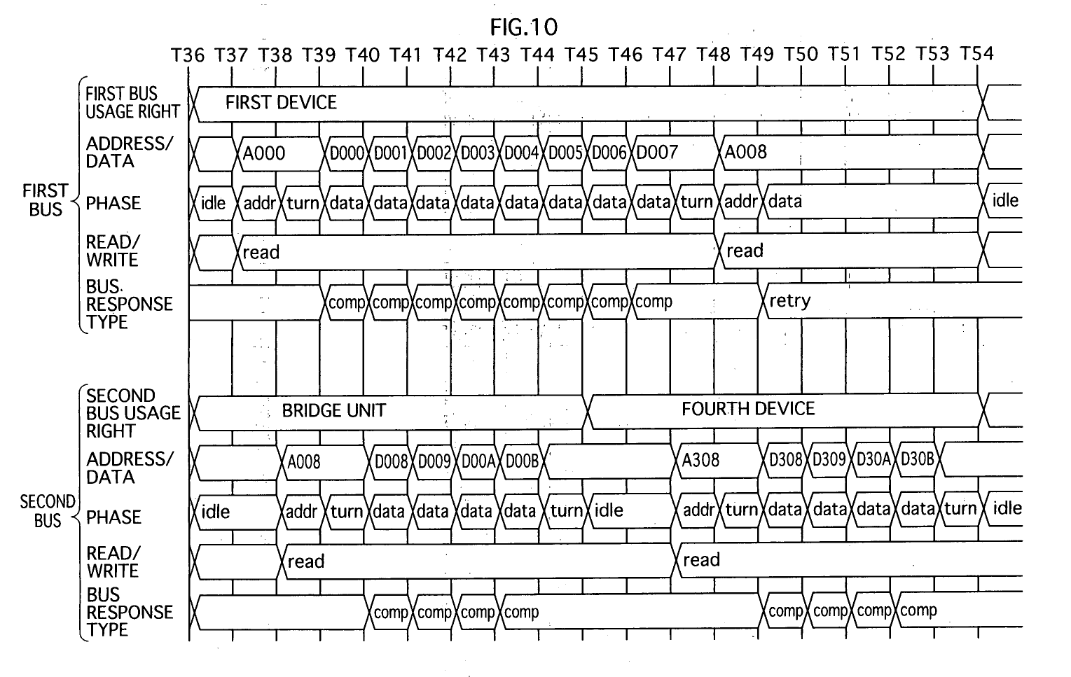

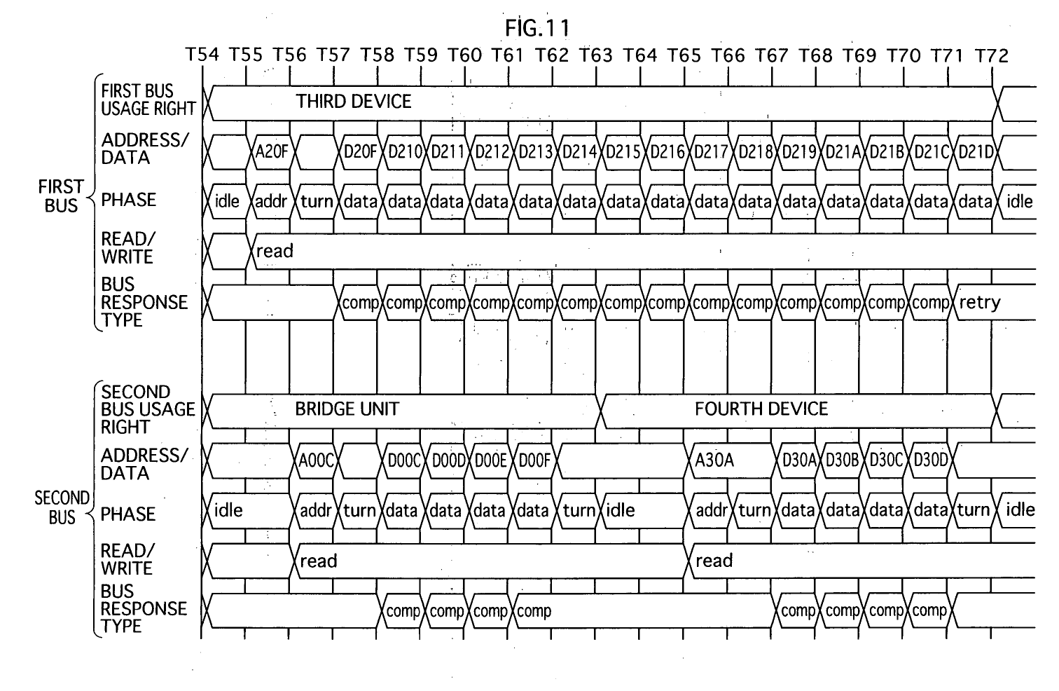

FIGS. 8 to 11 are timing charts showing temporal change of main signals that appear in the first bus and the second bus from a time T0 through to a time T72.

The upper half of each of FIGS. 8 to 11 shows signal content such as a signal expressing the usage right for the first bus, a first bus address/data signal, a first bus phase signal, a first bus read/write signal, and a signal expressing a bus response type of the first bus. The lower half of each of FIGS. 8 to 11 shows signal content such as a signal expressing the usage right for the second bus, a second bus address/data signal, a second bus phase signal, a second bus read/write signal, and a signal expressing a bus response type of the second bus.

The phase signal is either “addr(address)”, “data”, “turn”, or “idle”.

Furthermore, the bus response is either “comp(completion)” or “retry”.

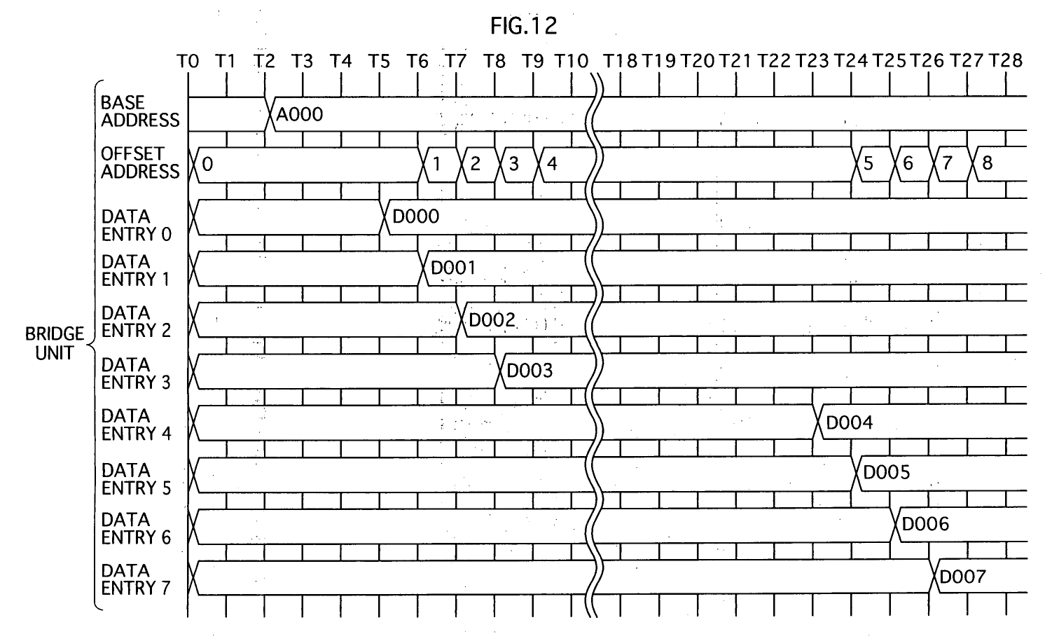

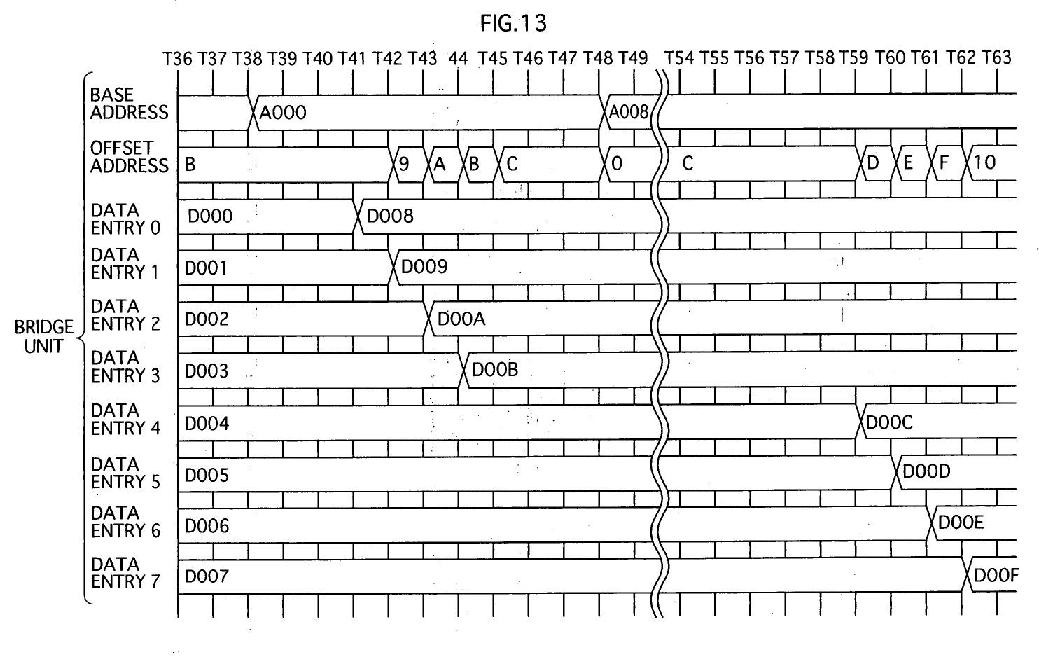

FIG. 12 and FIG. 13 are timing charts showing temporal change of data that the bridge unit 21a stores. Shown in order from the top are the contents of the following signals: base address, offset address, and data entries 0 to 7.

The following describes operations of the bus system 1a in terms of the passage of time shown in the time chart.

(T0 to T1)

The first bus is in an idle state, and therefore the first device, which has been given the usage right for the bus, commences bus transaction at T1.

(T1 to T2)

In the first bus, bus transaction commences by the first device driving A000, which is the head address of the area in which the data that the first device is attempting to read is located, to the address/data signal line. The read/write signal line shows that this bus transaction is a read operation. In the bridge unit the head address A000 is latched into the base address.

(T2 to T3)

In the first bus, since the bus transaction is a read, a so-called “turn around cycle” is inserted to prevent a collision on the address/data signal line in the bus.

In the second bus, bus transaction commences by the bridge unit driving A000, which is the head address of the area in which the data that the bridge unit is attempting to read is located, to the address/data signal line. The read/write signal line shows that this bus transaction is a read operation.

(T3 to T4)

In the first bus, the bridge unit responds to the address A000 that was driven in T1 to T2. The bridge unit returns a retry response since the read data is not yet ready.

In the second bus, since the bus transaction is a read, a turn around cycle is inserted to prevent a collision on the address/data signal line in the bus.

(T4 to T5)

In the first bus, the retry response is received, and the turn around cycle occurs.

In the second bus, the second device drives 4-byte data D000 onto the address/data signal line, and returns a completion response.

(T5 to T6)

In the first bus, idle cycles occur from T5 through to T18 where the 18-cycle allotted time given to the first device ends.

In the second bus, the second device drives 4-byte data D001 onto the address/data signal line, and returns a completion response.

The bridge unit latches the data D000 into the data entry 0.

(T6 to T7)

In the second bus, the second device drives 4-byte data D002 onto the address/data signal line, and returns a completion response.

Since data has been latched into a data entry in the previous cycle, the bridge unit increments the offset address by one, and latches data D001 into the data entry 1.

(T7 to T8)

In the second bus, second device drives 4-byte data D003 onto the address/data signal line, and returns a completion response.

Since data has been latched into a data entry in the previous cycle, the bridge unit increments the offset address by one, and latches data D002 into the data entry 2.

(T8 to T9)

In the second bus, the bridge unit's usage right for the bus ends at the time T9.

Since data has been latched into a data entry in the previous cycle, the bridge unit increments the offset address by one, and latches data D003 into the data entry 3.

(T9 to T10)

In the second bus, the bus usage right is given to the fourth device until T18. Since data has been latched into a data entry in the previous cycle, the bridge unit increments the offset address by one.

(T10 to T18)

In the second bus, the fourth device performs bus access.

(T18 to T27)

In the first bus, the bus usage right is given to the third device from the time T18.

In the second bus, the bridge unit generates a bus cycle from time T20 to T27, and data D004, D005, D006, and D007 are latched into bridge unit data entries in the same way as at times T0 to T9.

(T27 to T36)

In the first bus, the bus usage right continues to be held by the third device.

In the second bus, the fourth device performs bus access.

(T36 to T54)

In the first bus, the bus usage right is given to the first device. Bus transaction commences in the first bus by the first device driving A000, which is the head address of the area in which the data that the first device is attempting to read is located, to the address/data signal line.

The bridge unit drives four bytes of data in the data entries at a time each one cycle from T39 to T46.

After a one-cycle turn around cycle, the first device commences the next bus transaction, and drives the head address A008. The bridge unit returns a retry response.

In the second bus, first the bus usage right is given to the bridge unit, and data D008, D009, D00A, and D00B are latched into data entries in the same way as at times T18 to T27. Next, the fourth device, which is given the bus usage right at T45 to T54, performs bus access.

(T54 to T72)

In the first bus, the third device performs bus access.

In the second bus, data D00C, D00D, D00E, and D00F are latched into bridge unit data entries in the same way as at times T36 to T53. Next, the fourth device performs bus access at T63 to T72.

### SECOND MODIFICATION EXAMPLE

The following describes a second modification example.

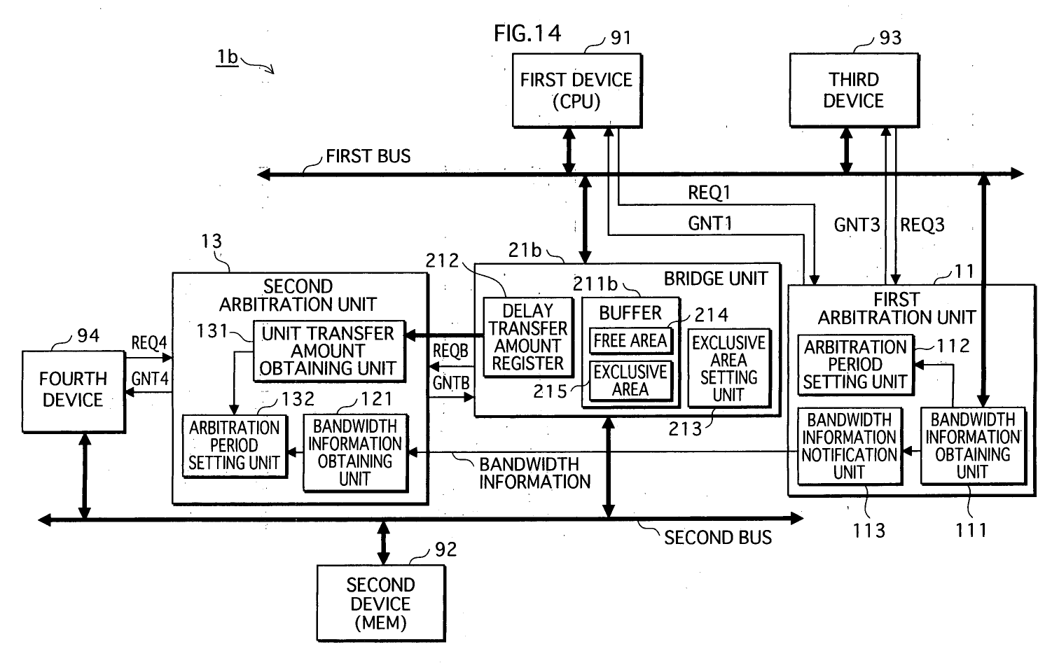

FIG. 14 is a function block diagram showing the overall structure of a bus system 1b relating to the second modification example.

The bus system 1b differs from the bus system 1a shown in FIG. 6 in terms of a bridge unit 21b additionally having a buffer 211b that is used divided into an exclusive area 215 for storing transfer data exclusively and a free area 214 for storing other data, and an exclusive area setting unit 213 that sets the exclusive area 215 in the buffer 211b.

The size of the exclusive area 215 is at least the unit transfer amount d, and preferably at least the data amount D that is to be transferred each cycle. This prevents a situation where the bridge unit is unable to store new transfer data due to insufficient buffer space, and enables data to be transferred efficiently.

The free area 214 is used to store data other than transfer data.

Changes in the proportion of the exclusive area 215 to the free area 214 are performed by the exclusive area setting unit 213 without changing the hardware structure.

### THIRD MODIFICATION EXAMPLE

In the structure described so far, the second arbitration unit obtains information regarding the unit transfer amount d. However, the unit transfer amount d may be set from a function unit other than the bridge unit 21a.

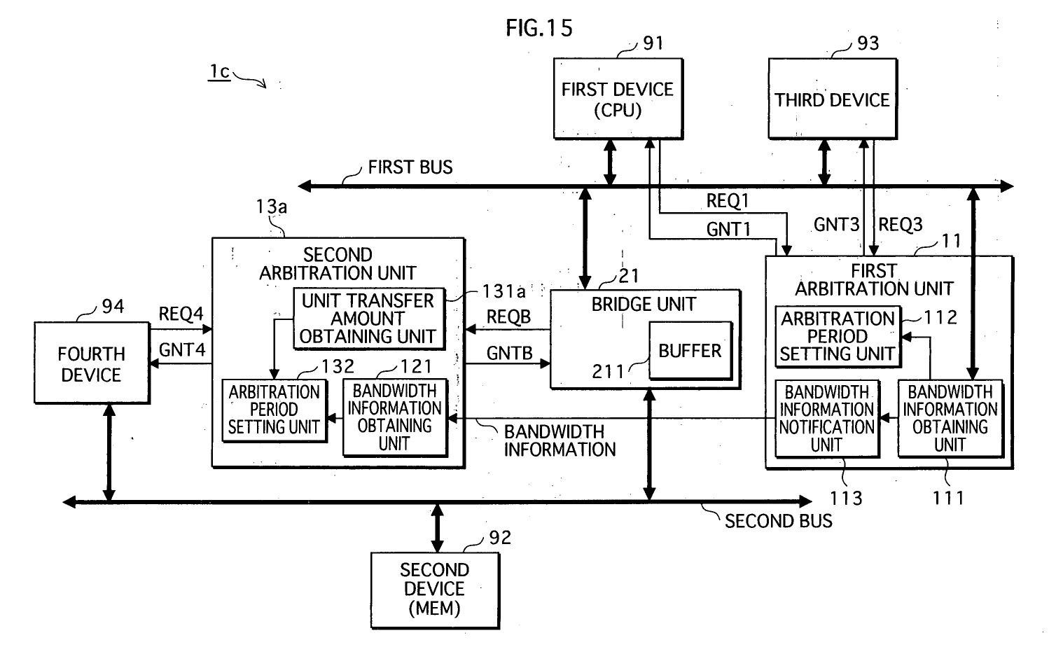

As one example, FIG. 15 shows a bus system 1c in which information regarding the unit transfer amount d can be obtained and set via the first bus.

In FIG. 15, a second arbitration unit 13a has a unit transfer amount obtaining unit 131a which obtains information regarding the unit transfer amount d via the first bus.

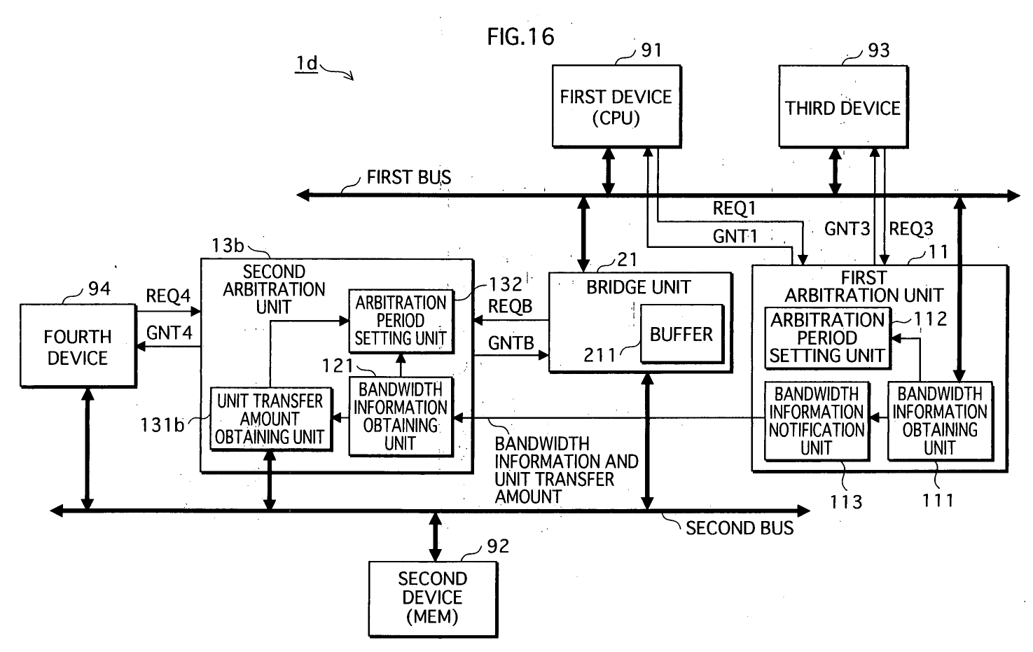

FIG. 16 shows the structure of a bus system 1d in which information regarding the unit transfer amount d can be obtained and set via the second bus.

In FIG. 16, a second arbitration unit 13b has a unit transfer amount obtaining unit 131b which obtains information regarding the unit transfer amount d via the second bus.

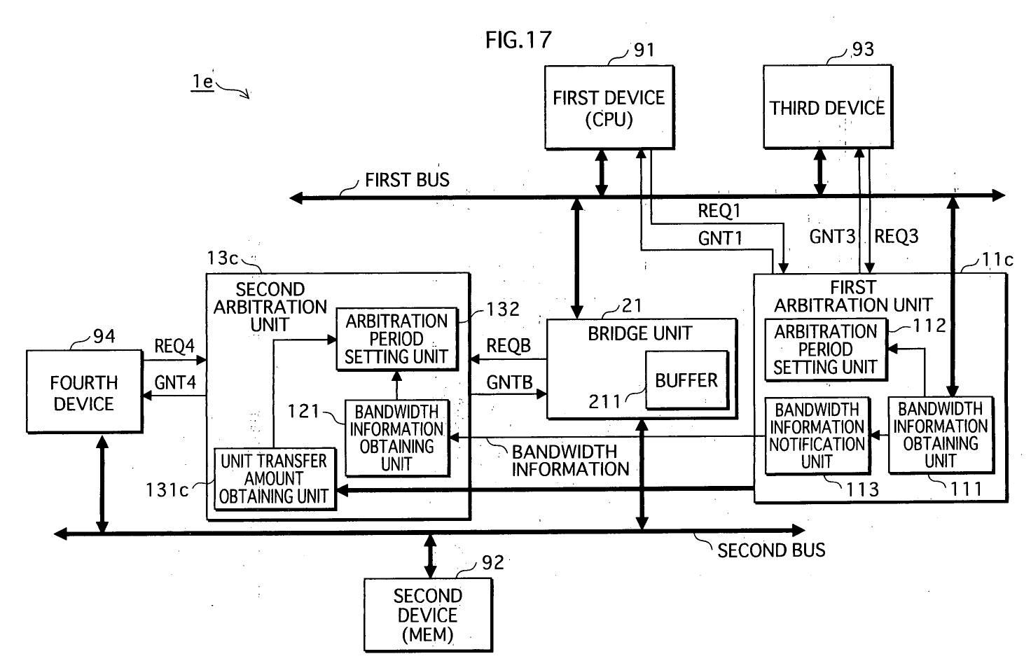

FIG. 17 shows the structure of a bus system 1e in which information regarding the unit transfer amount d can be obtained and set from a first arbitration unit 11c.

In FIG. 17, a second arbitration unit 13c has a unit transfer amount obtaining unit 131c which obtains information regarding the unit transfer amount d from the first arbitration unit 11c.

### FOURTH MODIFICATION EXAMPLE

As in the described specific example, if the bandwidth information shows that transfer of 32 bytes of data each 36 bus cycles is requested between the first device 91 and the second device 92, it is possible to use a different method to set the arbitration cycle, the allocated time, and the like.

When no restriction exists on the unit transfer amount, the first bus arbitration cycle and the second bus arbitration cycle may be the same. Here, as one example, the first bus arbitration cycle S1 is set as 36 bus cycles, the allocated time A1 for which the usage right for the first bus is given to the first device is set as 18 bus cycles, the second bus arbitration cycle S2 is set as 36 cycles, and the allocated time A2 for which the usage right for the first bus is given to the bridge unit is set as 18 bus cycles.

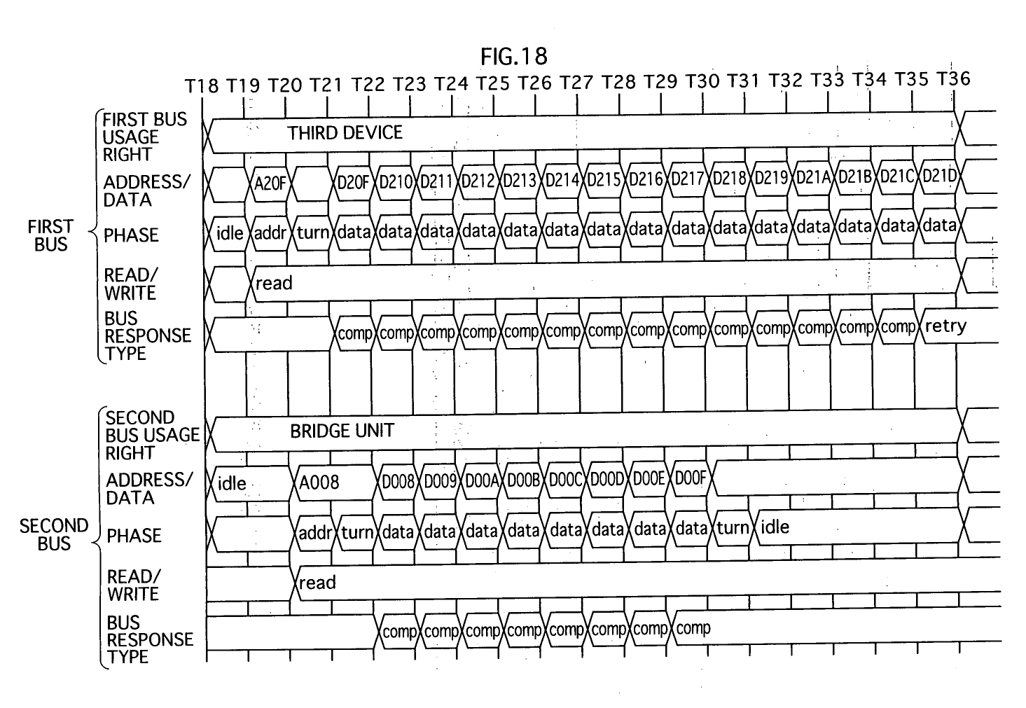

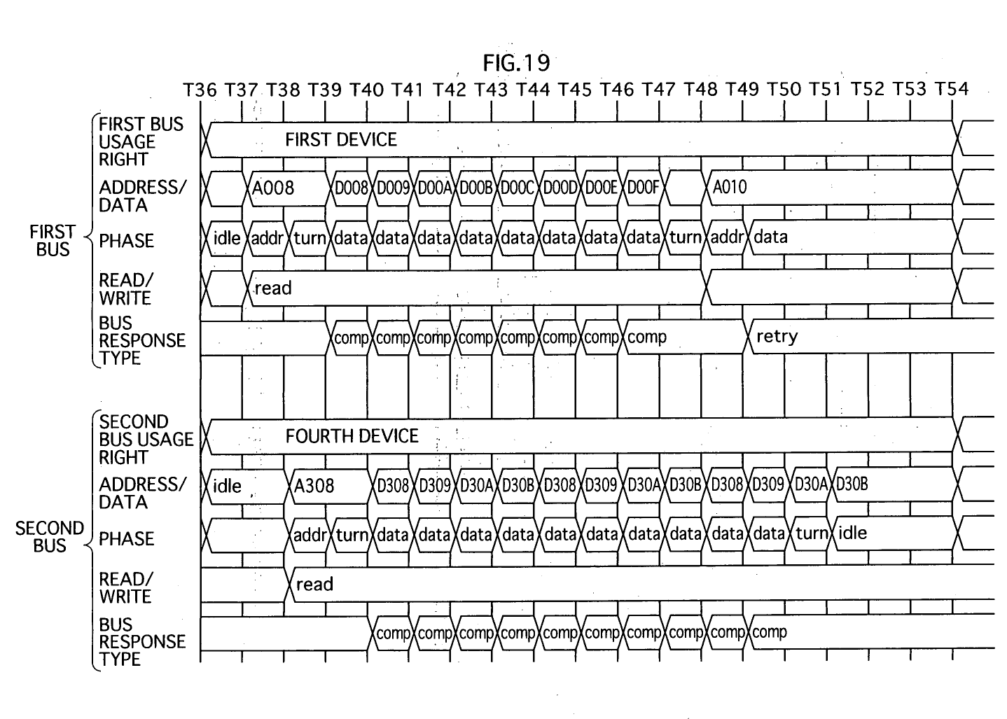

FIG. 18 and FIG. 19 are timing charts showing temporal changes of main signals that appear in the first bus and the second bus from a time T18 through to a time T54 in the aforementioned case.

With the described settings, the number of bus transactions in the second bus is half that in the previous specific example (see FIG. 8 to FIG. 11). This lightens the overhead for issuing commands.

Furthermore, the allocated time A1 for which the usage right for the first bus is given to the first device may be made to be equivalent to the total of (i) the time required to transfer data of the maximum capacity of the buffer 211, (ii) the time required to issue a command relating to the transfer, and (iii) the time required to issue a bus command relating to the next bus transaction. For example, if up to 32 bytes of transfer data is stored in the buffer 211, the allocated time A1 may be 14 bus cycles, which is the total of 8 bus cycles for data transfer, and 3 bus cycles to issue each command (each including one turn around cycle), and the first bus arbitration cycle S1 may be 28 bus cycles.

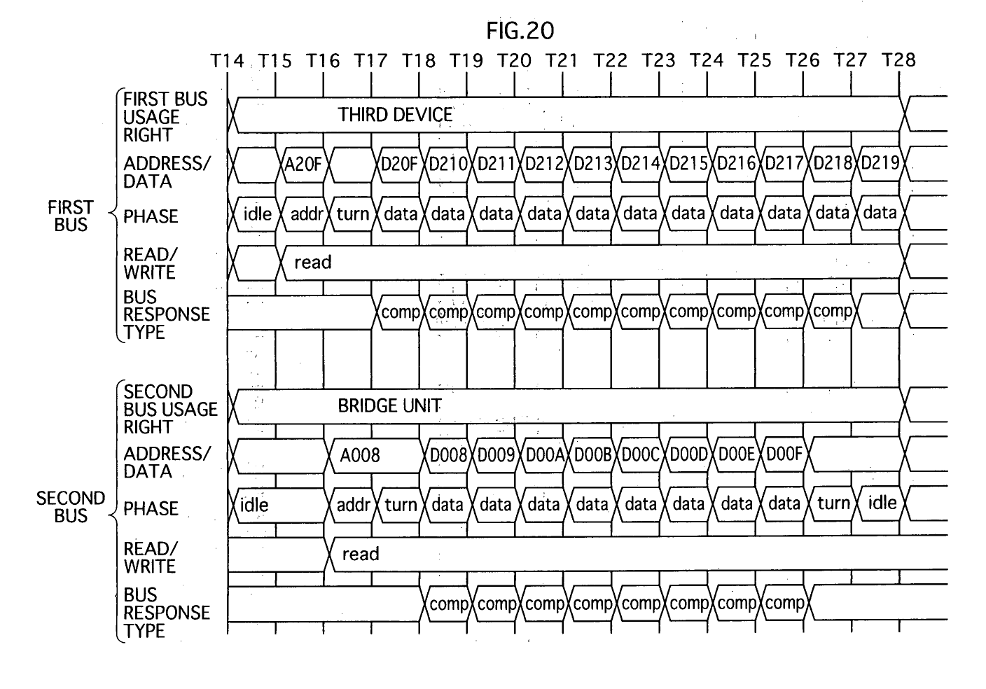

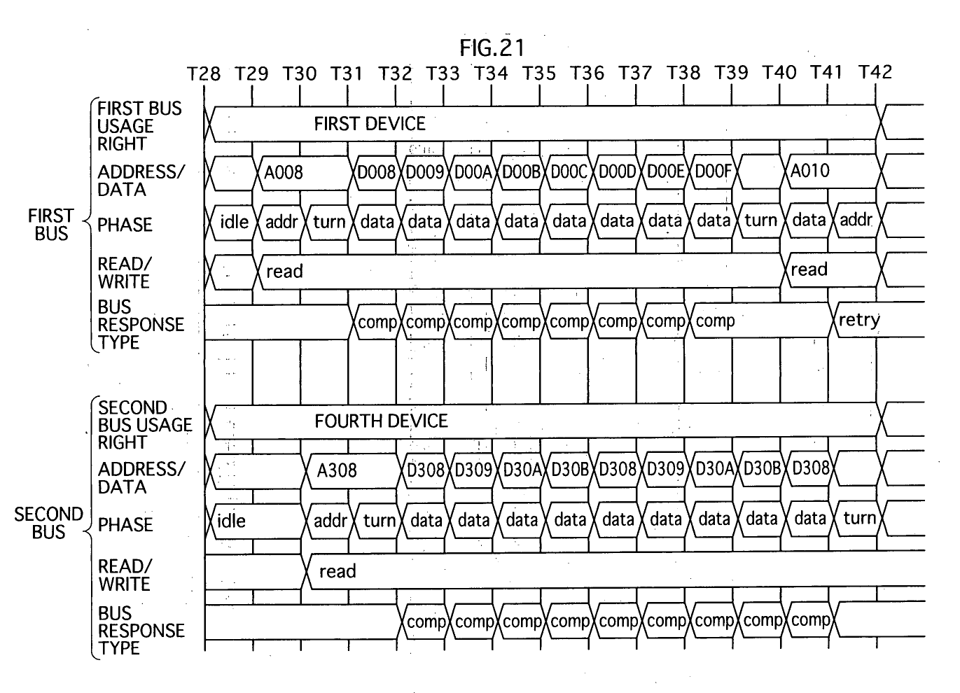

FIG. 20 and FIG. 21 are timing charts showing temporal changes of main signals that appear in the first bus and the second bus from a time T14 through to a time T44 in the aforementioned case.

With the described settings, the time relating to data transfer is relatively short compared to the previous specific example due to the minimal number of idle cycles (see FIG. 8 to FIG. 11).

Furthermore, the first device may free the usage right for the first bus when it has ended its bus transaction.

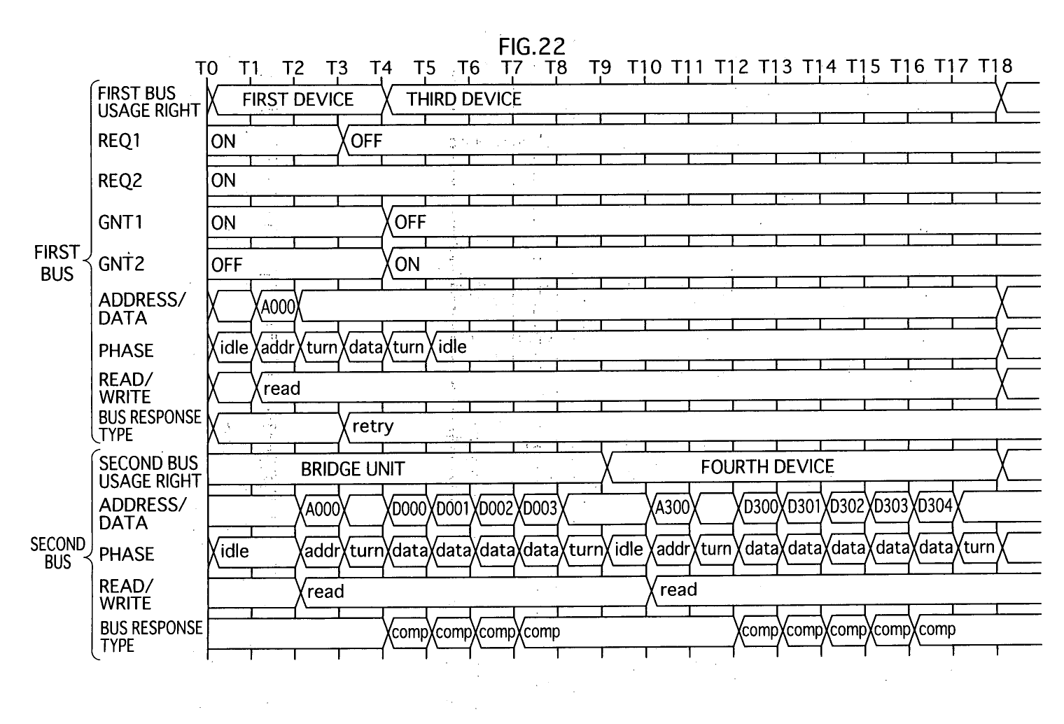

FIG. 22 is a timing chart showing time changes of main signals that appear in the first bus and the second bus from a time T0 through to a time T18, in a case where the first device frees the usage right for the first bus at time T4.

With the described settings, the usage right for the first bus is passed promptly from the first device 91 to another device, particularly when a retry response is returned from the bridge unit in the initial read transaction. This improves bus usage efficiency.

### Second Embodiment

### Structure

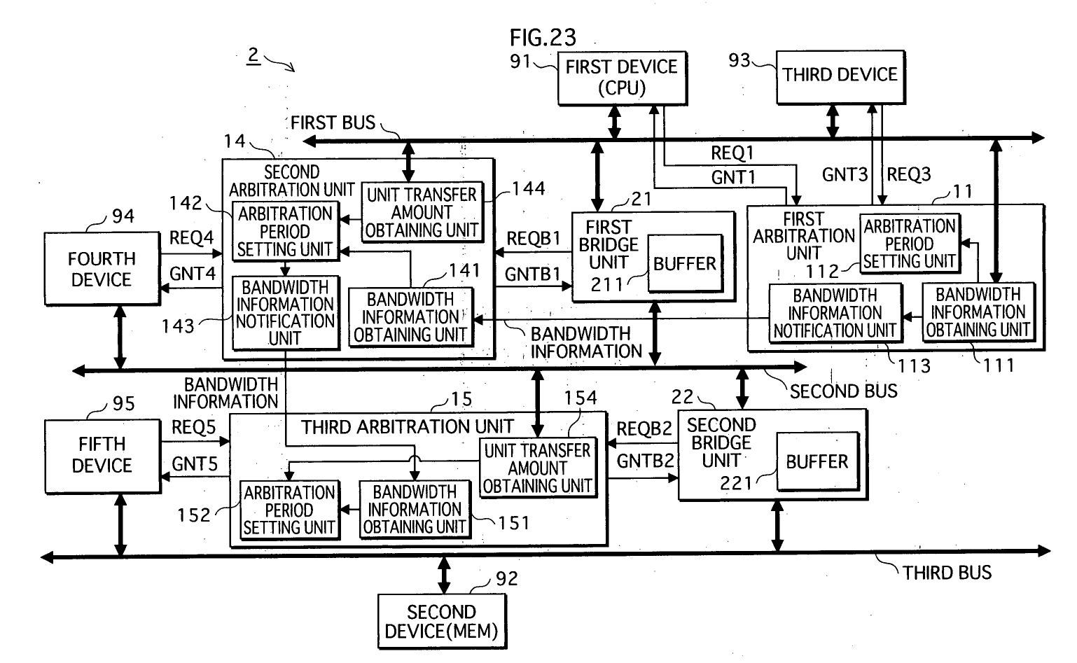

FIG. 23 shows the structure of a bus system 2 that includes a bus control device relating to the second embodiment.

The bus system 2 includes the first bus and the second bus which are connected via a first bridge unit 21, a third bus connected to the second bus via a second bridge unit 22, the first device 91 and the third device 93 which are connected to the first bus, the fourth device 94 which is connected to the second bus, the second device 92 and a fifth device 95 which are connected to a third bus, the first arbitration unit 11 which arbitrates the usage right for the first bus, a second arbitration unit 14 which arbitrates the usage right for the second bus, and a third arbitration unit 15 which arbitrates the usage right for the third bus.

The first arbitration unit 11, the second arbitration unit 14, third arbitration unit 15, the first bridge unit 21, and the second bridge unit 22 are implemented with an integrated circuit.

The bus control device is composed of the first arbitration unit 11, the second arbitration unit 14, and the third arbitration unit 15.

The first arbitration unit 11 has the bandwidth information obtaining unit 111, the arbitration period setting unit 112, and the bandwidth information notification unit 113.

The second arbitration unit 14 has a bandwidth information obtaining unit 141, an arbitration period setting unit 142, a bandwidth information notification unit 143, and a unit transfer amount obtaining unit 144.

The third arbitration unit 15 has a bandwidth information obtaining unit 151, an arbitration period setting unit 152, and a unit transfer amount obtaining unit 154.

The first bridge unit 21 has the buffer 211 that temporarily stores data to be transferred between the first bus and the second bus.

The second bridge unit 22 has a buffer 221 that temporarily stores data to be transferred between the second bus and the third bus.

### Operations

In the bus system 2, when the first device 91 performs playback processing with respect to the MP3 data stored in the second device 92, arbitration of the usage rights for the first bus, the second bus and the third bus is performed in order to guarantee bandwidth for data transfer between the first device 91 and the second device 92.

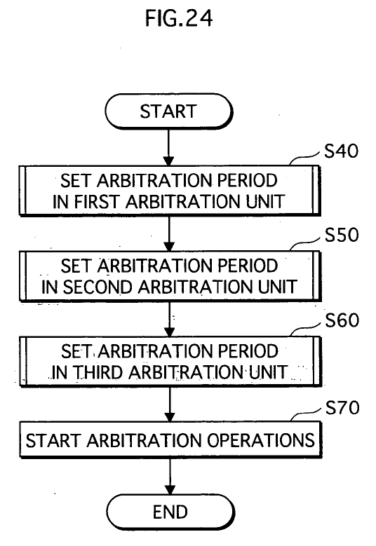

FIG. 24 is a flowchart expressing an outline of operations of the bus system 2.

First, the period for which the usage right for the first bus is given to the first device is set in the first arbitration unit 11 (step S40), the period for which the usage right for the second bus is given to the first bridge unit is set in the second arbitration unit 14 (step S50), and the period for which the usage right for the third bus is given to the second bridge unit is set in the third arbitration unit 15 (step S60).

These operations complete configuration of the bus control device relating to the data transfer bandwidth.

Next, arbitration operations commence in accordance with what has been set in the first arbitration unit 11, the second arbitration unit 14, and the third arbitration unit 15, and the bus system 2 performs transfer of data (step S70).

Details of the setting operations in the first arbitration unit 11 are the same as those described in the first embodiment (see FIG. 4), and therefore are omitted here. The following describes details of setting operations in the second arbitration unit 14 and the third arbitration unit 15.

### Operations of the Second Arbitration Unit

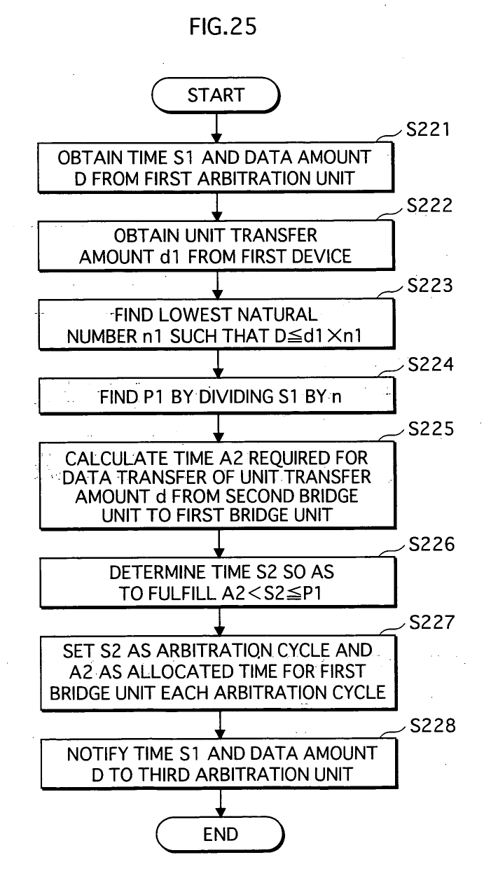

FIG. 25 is a flowchart expressing details of setting operations in the second arbitration unit 14.

The bandwidth information obtaining unit 141 obtains, as bandwidth information, the time S1 and the data amount D from the first arbitration unit 11 (step S221), and the unit transfer amount obtaining unit 144 obtains the unit transfer amount d1 from the first device 91 (step S222).

The arbitration period setting unit 142 finds the smallest natural number n1 that when multiplied with the unit transfer amount d1 will result in a value that is equal to or greater than the data amount D (step S223), and finds P1 by dividing the time S1 by n1 (step S224). Next, the arbitration period setting unit 142 calculates a time A2 required for data transfer of the unit transfer amount d1 from the second bridge unit 22 to the first bridge unit 21 (step S225), determines a time S2 that fulfills A2<S2≦P1 (step S226), and sets S2 as the arbitration cycle of the second bus, and A2 as the allocated time for which the usage right for the second bus is given to the first bridge unit 21 each arbitration cycle (step S227). Furthermore, the arbitration period setting unit 142 notifies the time S1 and the data amount D to the third arbitration unit 15 (step S228).

### Operations of the Third Arbitration Unit

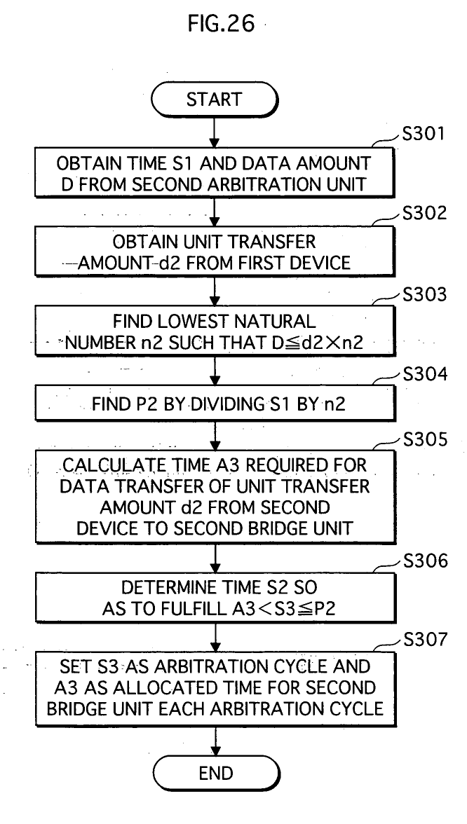

FIG. 26 is a flowchart expressing details of setting operations in the third arbitration unit 15.

The bandwidth information obtaining unit 151 obtains, as bandwidth information, the time S1 and the data amount D from the second arbitration unit 14 (step S301), and the unit transfer amount obtaining unit 154 obtains the unit transfer amount d2 from the first device 91 via the first bridge unit 21 (step S302).

Next, the arbitration period setting unit 152 finds the smallest natural number n2 that when multiplied with the unit transfer amount d2 will result in a value that is equal to or greater than the data amount D (step S303), and finds P2 by dividing the time S1 by n2 (step S304). Next, the arbitration period setting unit 152 calculates a time A3 required for transfer of the unit transfer amount d2 from the second device 92 to the second bridge unit 22 (step S305), determines a time S3 that fulfills A3<S3≦P2 (step S306), and sets S3 as the arbitration cycle of the third bus, and A3 as the allocated time for which the usage right for the third bus is given to the second bridge unit 22 each arbitration cycle (step S307).

By the first arbitration unit 11, the second arbitration unit 14, and the third arbitration unit 15 performing arbitration operations in accordance with the described settings, the usage rights for the first bus, the second bus, and the third bus are given respectively to the first device 91, the first bridge unit 21, and the second bridge unit 22 for the periods necessary to ensure the bandwidths shown in the bandwidth information.

### MODIFICATION EXAMPLE

The third arbitration unit may obtain the transfer amount d2 from the second arbitration unit.

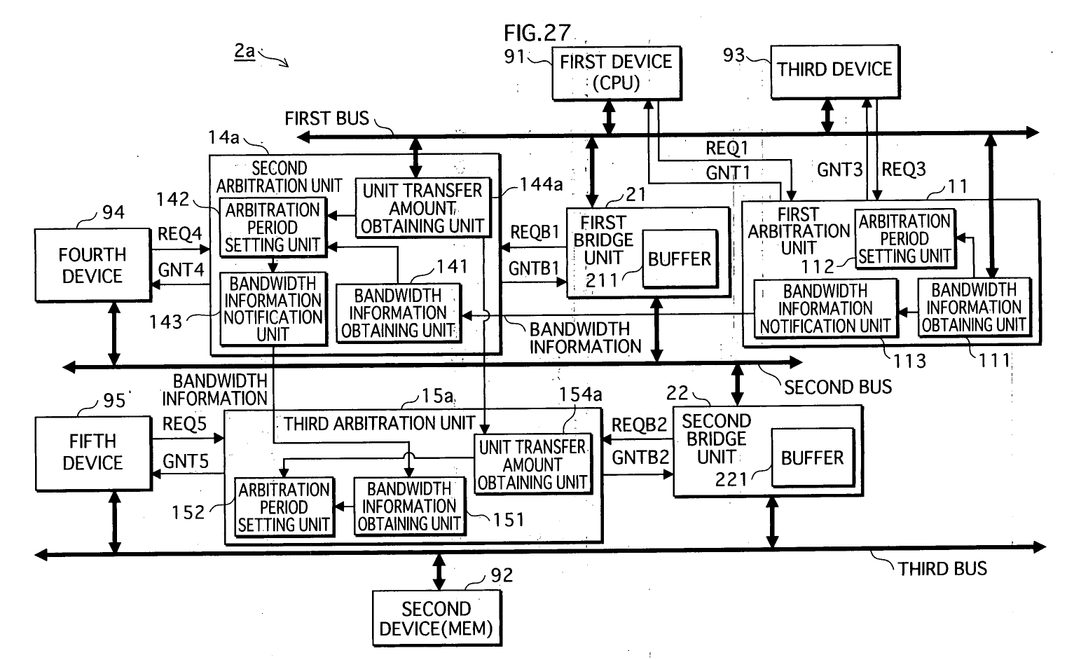

FIG. 27 shows the structure of a bus system 2a.

The bus system 2a differs from the bus system 2 in that a unit transfer amount obtaining unit 144a in a second arbitration unit 14a relays the unit transfer amount d2 from the first device 91 to the third arbitration unit 15a, and that a unit transfer amount obtaining unit 154a in the third arbitration unit 15a obtains the unit transfer amount d2 from the unit transfer amount obtaining unit 144a in the second arbitration unit 14a.

### Third Embodiment

### Structure

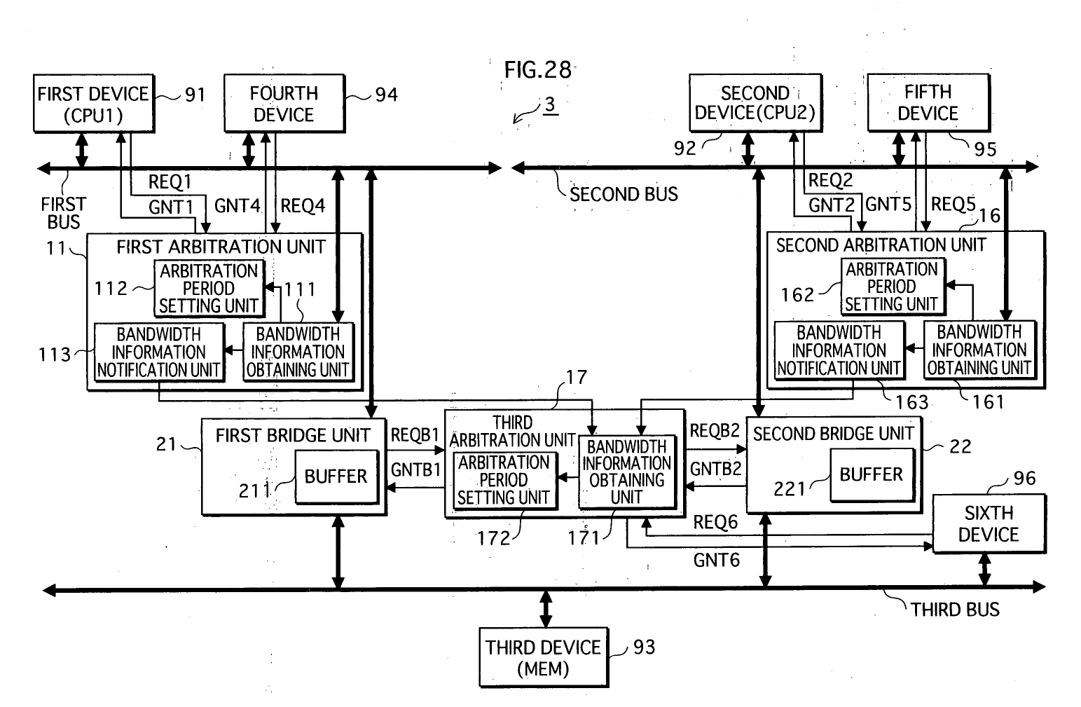

FIG. 28 shows the structure of a bus system 3 that includes a bus control device relating to the third embodiment.

The bus system 3 includes the first bus and the third bus which are connected via the first bridge unit 21, the second bus which is connected to the third bus via the second bridge unit 22, the first device 91 and the fourth device 94 which are connected to the first bus, the second device 92 and the fifth device 95 which are connected to the second bus, the third device 93 and a sixth device 96 which are connected to third bus, the first arbitration unit 11 which arbitrates the usage right for the first bus, a second arbitration unit 16 which arbitrates the usage right for the second bus, and a third arbitration unit 17 which arbitrates the usage right for the third bus.

The first arbitration unit 11, the second arbitration unit 16, the third arbitration unit 17, the first bridge unit 21 and the second bridge unit 22 are implemented with an integrated circuit.

The bus control device is composed of the first arbitration unit 11, the second arbitration unit 16, and the third arbitration unit 17.

The first arbitration unit 11 has the bandwidth information obtaining unit 111, the arbitration period setting unit 112, and the bandwidth information notification unit 113.

The second arbitration unit 16 has a bandwidth information obtaining unit 161, an arbitration period setting unit 162, and a bandwidth information notification unit 163.

The third arbitration unit 17 has a bandwidth information obtaining unit 171, and an arbitration period setting unit 172.

The first bridge unit 21 has the buffer 211 that temporarily stores data to be transferred between the first bus and the third bus.

The second bridge unit 22 has the buffer 221 that temporarily stores data to be transferred between the second bus and the third bus.

### Operations

In the bus system 3, arbitration of the usage rights for the first bus, the second bus, and the third bus is performed in order to guarantee bandwidth for data transfer performed in parallel between the first device 91 which is a first CPU and the third device 93 which is a memory device, and between the second device 92 which is a second CPU and the third device 93.

Details of setting operations in the first arbitration unit 11 are the same as the operations described in the first embodiment (see FIG. 4) with the exception of the use of first bandwidth information that shows that transfer of a data amount D1 each time S1 is requested between the first device 91 and the third device 93, and the exception that the time S1 and the data amount D1 are notified to the third arbitration unit.

Details of setting operations in the second arbitration unit 16 are the same as the operations described in the first embodiment (see FIG. 4) with the exception of the use of second bandwidth information that shows that transfer of a data amount D2 each time S2 is requested between the second device 92 and the third device 93, and the exception that the time S2 and the data amount D2 are notified to the third arbitration unit.

A detailed explanation of these setting operations is omitted, the following describing details of the setting operations in the third arbitration unit 17.

### Operations of the Third Arbitration Unit

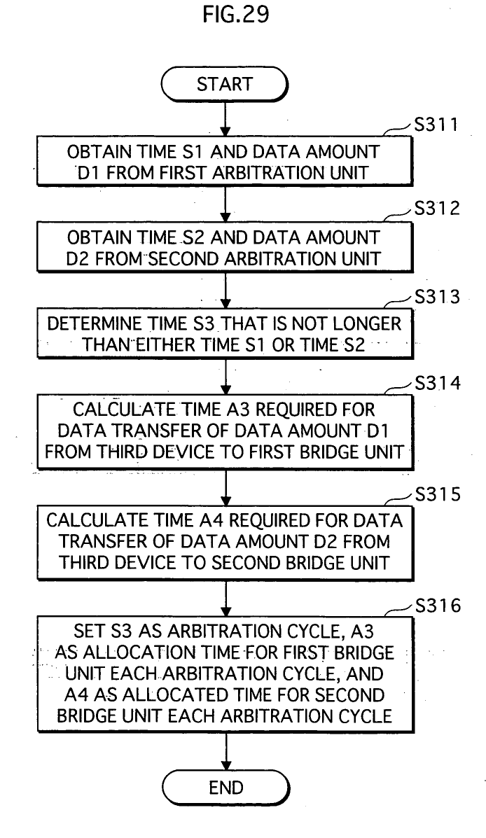

FIG. 29 is a flowchart expressing details of setting operations in the third arbitration unit 17.

The bandwidth information obtaining unit 171 obtains, as the first bandwidth information, the time S1 and the data amount D1 from the first arbitration unit 11 (step S311), and obtains, as the second bandwidth information, the time S2 and the data amount D2 from the second arbitration unit 16 (step S312).

The arbitration period setting unit 172 determines a time S3 that is no longer than either the time S1 or the time S2 (step S313), calculates a time A3 required for data transfer of a data amount D1 from the third device 93 to the first bridge unit 21 (step S314), and calculates a time A4 required for data transfer of a data amount D2 from the third device 93 to the second bridge unit 22 (step S315).

The arbitration period setting unit 172 sets S3 as the arbitration cycle of the third bus, and A3 as the allocated time for which the usage right for the third bus is given to the first bridge unit 21 each arbitration cycle, and A4 as the allocated time for which the usage right for the third bus is given to the second bridge unit 22 each arbitration cycle (step S316).

By the first arbitration unit 11, the second arbitration unit 16, and the third arbitration unit 17 performing arbitration operations in accordance with the described settings, the usage rights for the first bus, the second bus, and the third bus are respectively given to the first device 91, the first bridge unit 21, and the second bridge unit 22 for the periods necessary to ensure the bandwidths shown in the bandwidth information.

### Additional Remarks

This completes the description of embodiments of the present invention. The present invention is by no means limited to the above-described embodiments, and cases such as the following are included in the present invention.

(1) In the first embodiment, although the bus control device is described as being composed of the first arbitration unit 11 and the second arbitration unit 12, the bridge unit 21 may also be included in the bus control device. In the second embodiment, although the bus control device is described as being composed of the first arbitration unit 11, the second arbitration unit 14 and the third arbitration unit 15, the first bridge unit 21 and the second bridge unit 22 may also be included in the bus control device. In the third embodiment, although the bus control device is described as being composed of the first arbitration unit 11, the second arbitration unit 16 and the third arbitration unit 17, the first bridge unit 21 and the second bridge unit 22 may also be included in the bus control device.

(2) In the first embodiment, although the first arbitration unit 11, the second arbitration unit 12 and the bridge unit 21 are described as being an integrated circuit, these may instead be realized with an ASIC (Application Specific Integrated Circuit), and FPGA (Field Programmable Gate Array), or hardware such as a configurable processor in which connections, settings, and the like in circuit cells in the integrated circuit are re-configurable. The stated function units may realized with individual chips, or with one chip that includes part or all the function units. Furthermore, the first arbitration unit 11, the second arbitration unit 12, and the bridge unit 21 may be realized with software, in which case function blocks of these units correspond to program modules. The corresponding concrete functions are realized by a general-purpose processor (not illustrated) executing the program modules.

(3) The present invention can be applied to a bus system that uses a bus in which addresses and data are conveyed respectively on separate signal lines.

(4) The present invention may be methods that include the respective steps of the operations described in the embodiments. Furthermore, the present invention may be a computer program for realizing any of these the methods using a computer system, and may be a digital signal that expresses the program.

(5) The present invention may be a computer-readable recording medium that has the program or the digital signal recorded thereon, examples of the recording medium being a flexible disk, a hard disk, a CD, an MO, a DVD, a BD, and a semiconductor memory.

(6) The present invention may be the computer program or the digital signal transmitted on an electric communication network, a wireless or wired communication network, or a network of which the Internet is representative.

(7) The present invention may be a computer system that includes a microprocessor and a memory, the memory storing the computer program, and the microprocessor operating according to the computer program stored in the memory. Furthermore, by transferring the program or the digital signal to the recording medium, or by transferring the program or the digital signal via a network or the like, the program or the digital signal may be executed by another independent computer system.

Although the present invention has been fully described by way of examples with reference to the accompanying drawings, it is to be noted that various changes and modification will be apparent to those skilled in the art. Therefore, unless otherwise such changes and modifications depart from the scope of the present invention, they should be construed as being included therein.

What is claimed is:

1. A bus control device for controlling a bus system, the bus system being composed of a first bus and a second bus connected via a bridge unit, the bus control device comprising:
a first arbitration unit operable to obtain bandwidth information that specifies required bandwidth for data transfer between a first device connected to the first bus and a second device connected to the second bus, and give a usage right for the first bus to the first device for a first allocated period set in accordance with the obtained bandwidth information;
a second arbitration unit operable to arbitrate a usage right for the second bus; and
a notification unit operable to notify the bandwidth information from the first arbitration unit to the second arbitration unit,
wherein the second arbitration unit gives the usage right for the second bus to the bridge unit for a second allocated period set in accordance with the bandwidth information notified by the first arbitration unit.

2. The bus control device of claim 1, wherein
the bandwidth information expresses a first cycle and a transfer amount of data to be transferred between the first device and the second device in each first cycle,
the first arbitration unit sets the first allocated period in each first cycle, the first allocated period being (i) equal to or longer than a time taken for transfer of the transfer amount of data between the bridge unit and the first device and (ii) shorter than the first cycle, and
the second arbitration unit sets the second allocated period in each second cycle, the second cycle being equal to or shorter than the first cycle, and the second allocated period being (i) equal to or longer than a time taken for transfer of the transfer amount of data between the second device and the bridge unit and (ii) shorter than the second cycle.

3. The bus control device of claim 2, wherein
in each one data transfer between the second device and the bridge unit, a unit transfer amount of data is transferred, the unit transfer amount being less than the transfer amount,
the second arbitration unit sets a plurality of separate allocated periods in each second cycle, a total of the separate allocated periods being equal to or longer than the second allocated period, and gives the usage right for the second bus to the bridge unit for each set separate allocated period, and
each separate allocated period is equal to a time taken for transfer of the unit transfer amount of data between the second device and the bridge unit.

4. The bus control device of claim 2, further comprising the bridge unit, wherein
the bridge unit has a storage unit capable of storing, up to a storage amount that is less than the transfer amount, data transferred between the first device and the second device,
the first arbitration unit sets a plurality of first separate allocated periods in each first cycle, a total of the first separate allocated periods being equal to or longer than the first allocated period, and gives the usage right for the first bus to the first device for each set first allocated period,
the second arbitration unit sets a plurality of second separate allocated periods in each second cycle, a total of the second separate allocated periods being equal to or longer than the second allocated period, and gives the usage right for the second bus to the bridge unit for each second allocated period,
each first separate allocated period is equal to a time taken for transfer of the storage amount of data between the bridge unit and the first device, and each second separate allocated period is equal to a time taken for transfer of the storage amount of data between the second device and the bridge unit.

5. The bus control device of claim 2, further comprising the bridge unit,
wherein the bridge unit has a storage unit capable of storing the transfer amount or more of data, and
the storage unit has an exclusive section for storing data transferred between the first device and the second device.

6. A bus control device for controlling a bus system, the bus system being composed of a first bus and a second bus connected via a first bridge unit and a third bus connected to the second bus via a second bridge unit, the bus control device comprising:
a first arbitration unit operable to obtain bandwidth information that specifies required bandwidth for data transfer between a first device connected to the first bus and a second device connected to the third bus, and give a usage right for the first bus to the first device for a first allocated period set in accordance with the obtained bandwidth information;
a second arbitration unit operable to arbitrate a usage right for the second bus;
a first notification unit operable to notify the bandwidth information from the first arbitration unit to the second arbitration unit;
a third arbitration unit operable to arbitrate a usage right for the third bus; and
a second notification unit operable to notify the bandwidth information from the second arbitration unit to the third arbitration unit,
wherein the second arbitration unit gives the usage right for the second bus to the bridge unit for a second allocated period set in accordance with the bandwidth information notified by the first arbitration unit, and
the third arbitration unit gives the usage right for the third bus to the second bridge unit for a third allocated period set in accordance with the bandwidth information notified by the second arbitration unit.

7. The bus control device of claim 6, wherein
the bandwidth information expresses a first cycle and a transfer amount of data to be transferred between the first device and the second device in each first cycle,
the first arbitration unit sets the first allocated period in each first cycle, the first allocated period being (i) equal to or longer than a time taken for transfer of the transfer amount of data between the first bridge unit and the first device and (ii) shorter than the first cycle, and
the second arbitration unit sets the second allocated period in each second cycle, the second cycle being equal to or shorter than the first cycle, and the second allocated period being (i) equal to or longer than a time taken for transfer of the transfer amount of data between the second device and the first bridge unit and (ii) shorter than the second cycle, and
the third arbitration unit sets the third allocated period in each third cycle, the third cycle being equal to or shorter than the first cycle, and the third allocated period being (i) equal to or longer than a time taken for transfer of the transfer amount of data between the second device and the second bridge unit and (ii) shorter than the third cycle.

8. A bus control device for controlling a bus system, the bus system being composed of a first bus and a third bus connected via a first bridge unit and second bus connected to the third bus via a second bridge unit, the bus control device comprising:
a first arbitration unit operable to obtain first bandwidth information that specifies required bandwidth for data transfer between a first device connected to the first bus and a third device connected to the third bus, and give a usage right for the first bus to the first device for a first allocated period set in accordance with the obtained first bandwidth information;
a second arbitration unit operable to obtain second bandwidth information that specifies required bandwidth for data transfer between a second device connected to the second bus and the third device, and give a usage right for the second bus to the second device for a second allocated period set in accordance with the obtained second bandwidth information;
a third arbitration unit operable to arbitrate a usage right for the third bus;
a first notification unit operable to notify the first bandwidth information from the first arbitration unit to the third arbitration unit; and
a second notification unit operable to notify the second bandwidth information from the second arbitration unit to the third arbitration unit,
wherein the third arbitration unit gives the usage right for the third bus to the first bridge unit for a third allocated period set in accordance with the first bandwidth information, and gives the usage right for the third bus to the second bridge unit for a fourth allocated period set in accordance with the second bandwidth information.

9. The bus control device of claim 8, wherein
the first bandwidth information expresses a first cycle and a first transfer amount of data to be transferred between the first device and the second device in each first cycle,
the second bandwidth information expresses a second cycle and a second transfer amount of data to be transferred between the second device and the third device in each second cycle,
the first arbitration unit sets the first allocated period in each first cycle, the first allocated period being (i) equal to or longer than a time taken for transfer of the first transfer amount of data between the first bridge unit and the first device and (ii) shorter than the first cycle,
the second arbitration unit sets the second allocated period in each second cycle, the second allocated period being (i) equal to or longer than a time taken for transfer of the transfer amount of data between the second bridge unit and the second device and (ii) shorter than the second cycle,
the third arbitration unit (a) sets a third allocated period in each third cycle, the third cycle being longer that each of the first cycle and the second cycle, and the third allocated period being (i) equal to or longer than a time taken for transfer of the first transfer amount of data between the third device and the first bridge unit and (ii) shorter than the third cycle, and (b) sets a fourth allocated period in each third cycle, the fourth allocated period being equal to or longer than a time taken for transfer of the second transfer amount of data between the third device and the second bridge unit.

10. An arbitration device for arbitrating a right to use a first bus in a bus system, the bus system being composed of the first bus and a second bus connected via a bridge unit, the arbitration device comprising:
an obtaining unit operable to obtain bandwidth information that specifies required bandwidth for data transfer between a first device connected to the first bus and a second device connected to the second bus;
an arbitration unit operable to give the right to use the first bus to the first device for an allocated period set in accordance with the obtained bandwidth information; and
a transmission unit operable to transmit bandwidth information to an arbitration device that arbitrates a usage right for the second bus.

11. An arbitration device that arbitrates a usage right for a second bus in a bus system, the bus system being composed of a first bus and the second bus connected via a bridge unit, the arbitration device comprising:
a reception unit operable to receive, from an arbitration device that arbitrates a usage right for the first bus, bandwidth information that specifies required bandwidth for data transfer between a first device connected to the first bus and a second device connected to the second bus; and
an arbitration unit operable to give the usage right for the second bus to the bridge unit for an allocated period set in accordance with the received bandwidth information.

12. An integrated circuit device for controlling a bus system, the bus system being composed of a first bus and a second bus connected via a bridge unit, the integrated circuit device comprising:
an input circuit operable to receive input of bandwidth information that specifies required bandwidth for data transfer between a first device connected to the first bus and a second device connected to the second bus;
a first arbitration circuit operable to output a first grant signal showing that the first device has a usage right for the first bus for a first allocated period set in accordance with the input bandwidth information;
a second arbitration circuit operable to arbitrate a usage right for the second bus; and
a notification circuit operable to notify the bandwidth information from the first arbitration circuit to the second arbitration circuit,
wherein the second arbitration circuit outputs a second grant signal showing that the bridge unit has a usage right for the second bus for a second allocated period set in accordance with the bandwidth information notified by the first arbitration circuit.

13. The integrated circuit device of claim 12, wherein
the input unit, as the bandwidth information, receives input of a first cycle and a transfer amount showing an amount of data to be transferred between the first device and the second device in each first cycle,
the first arbitration circuit sets the first allocated period in each first cycle, the first allocated cycle being (i) equal to or longer than a time taken for transfer of the transfer amount of data between the bridge unit and the first device and (ii) shorter than the first cycle, and
the second arbitration circuit sets the second allocated period each second cycle, the second cycle being equal to or shorter than the first cycle, and the second allocated period being (i) equal to or longer than a time taken for transfer of the transfer amount of data between the second device and the bridge unit and (ii) shorter than the second cycle.

14. An integrated circuit device for arbitrating a usage right for a first bus in a bus system, the bus system being composed of the first bus and a second bus connected via a bridge unit, the integrated circuit device comprising:
an input circuit operable to obtain bandwidth information that specifies required bandwidth for data transfer between a first device connected to the first bus and a second device connected to the second bus; and
an arbitration circuit operable to output a first grant signal showing that the first device has a usage right for the first bus for an allocated period set in accordance with the obtained bandwidth information; and
an output circuit operable to notify the bandwidth information to an integrated circuit device that arbitrates a usage right for the second bus.

15. An integrated circuit device for arbitrating a usage right for a second bus in a bus system, the bus system being composed of a first bus and the second bus connected via a bridge unit, the integrated circuit device comprising:
an input circuit operable to obtain bandwidth information that specifies required bandwidth for data transfer between a first device connected to the first bus and a second device connected to the second bus, from an integrated circuit device that arbitrates a usage right for the first bus; and
an arbitration circuit operable to give the usage right for the second bus to the bridge unit for an allocated period set in accordance with the obtained bandwidth information.

16. A bus control method for controlling a bus system, the bus system being composed of a first bus and a second bus connected via a bridge unit, a first arbitration unit for arbitrating a usage right for the first bus, and a second arbitration unit for arbitrating a usage right for the second bus, the bus control method comprising the steps of:
the first arbitration unit obtaining bandwidth information that specifies required bandwidth for data transfer between a first device connected to the first bus and a second device connected to the second bus, and giving the usage right for the first bus to the first device for a first allocated period set in accordance with the obtained bandwidth information;
the first arbitration unit notifying the bandwidth information to the second arbitration unit; and
the second arbitration unit giving the usage right for the second bus to the bridge unit for a second allocated period set in accordance with the bandwidth information notified by the first arbitration unit.

17. The bus control method of claim 16, wherein
the bandwidth information expresses a first cycle and a transfer amount of data to be transferred between the first device and the second device in each first cycle,
the first arbitration unit sets the first allocated period in each first cycle, the first allocated period being (i) equal to or longer than a time taken for transfer of the transfer amount of data between the bridge unit and the first device and (ii) shorter than the first cycle, and
the second arbitration unit sets the second allocated period in each second cycle, the second cycle being equal to or shorter than the first cycle, and the second allocated period being (i) equal to or longer than a time taken for transfer of the transfer amount of data between the second device and the bridge unit and (ii) shorter than the second cycle.

18. An arbitration method for arbitrating a usage right for a first bus in a bus system, the bus system being composed of the first bus and a second bus connected via a bridge unit, and a second arbitration unit for arbitrating a usage right for the second bus, the arbitration method comprising the steps of:
obtaining bandwidth information that specifies required bandwidth for data transfer between a first device connected to the first bus and a second device connected to the second bus;
giving the usage right for the first bus to the first device for an allocated period set in accordance with the obtained bandwidth information; and
transmitting the bandwidth information to the second arbitration unit.

19. An arbitration method for arbitrating a usage right for a second bus in a bus system, the bus system being composed of a first bus and the second bus connected via a bridge unit, and a first arbitration unit for arbitrating a usage right for the first bus, the arbitration method comprising the steps of:
receiving, from the first arbitration unit, bandwidth information that specifies required bandwidth for data transfer between a first device connected to the first bus and a second device connected to the second bus; and
giving the usage right for the second bus to the bridge unit for an allocated period set in accordance with the received bandwidth information.
